(19) United States
(12) Patent Application Publication
(10) Pub. No.: US 2024/0068197 A1
(43) Pub. Date: Feb. 29, 2024

(54) LIFT ARM ARRANGEMENTS FOR POWER MACHINES

(71) Applicant: Doosan Bobcat North America, Inc., West Fargo, ND (US)

(72) Inventors: Brent Durkin, Bismarck, ND (US); Michael Schmidt, Bismarck, ND (US); David Glasser, Bismarck, ND (US); Matthew Sagaser, Bismarck, ND (US); John Pfaff, Bismarck, ND (US); Dennis Agnew, Moffit, ND (US)

(21) Appl. No.: 18/456,992

(22) Filed: Aug. 28, 2023

Related U.S. Application Data
(60) Provisional application No. 63/401,451, filed on Aug. 26, 2022.
(60) Provisional application No. 63/489,455, filed on Mar. 10, 2023.
(60) Provisional application No. 63/489,466, filed on Mar. 10, 2023.

(51) Int. Cl. E02F 3/42; E02F 3/34; E02F 3/43

(52) U.S. Cl. CPC E02F 3/422; E02F 3/3405; E02F 3/431

(57) ABSTRACT

A loader can include a lift arm structure coupled to a frame. The lift arm structure can move between a fully-lowered position and a fully-raised position and can include a lift arm and a connecting link. A first end of the connecting link can be pivotally coupled to the frame at a first pivot point and the lift arm can be pivotally coupled to a second end of the connecting link a second pivot point. The lift arm structure can further include a lift actuator configured to pivot the lift arm about the second pivot point and an extension actuator configured to pivot the connecting link about the first pivot point. The extension and lift actuators can be controlled to move the lift arm along a variety of travel paths between any two points within a lift envelope of the lift arm structure.

### CROSS-REFERENCE TO RELATED APPLICATIONS

This application claims priority to and incorporated by reference U.S. provisional applications No. 63/401,451, filed Aug. 26, 2022, No. 63/489,455, filed Mar. 10, 2023, and No. 63/489,466, filed Mar. 10, 2023.

### BACKGROUND

This disclosure is directed toward power machines. More particularly, this disclosure is directed to a frame for power machines. Power machines, for the purposes of this disclosure, include any type of machine that generates power to accomplish a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders (including mini-loaders), excavators, utility vehicles, mowers, tractors (including compact tractors), and trenchers, to name a few examples.

Power machines can generally include workgroup actuators and other workgroup work elements (e.g., lift arm structures), as well as tractive (or drive) actuators and other tractive work elements (e.g., tracked or wheeled ground-engaging assemblies).

The discussion above is merely provided for general background information and is not intended to be used as an aid in determining the scope of the claimed subject matter.

### SUMMARY

Some examples of the present disclosure can provide improved lift arm structures for power machines (e.g., a remotely operated power machine), for moveably operating an implement. In particular, some implementations can increase a maximum lift height of a lift arm structure in a fully-raised position, while maintaining or reducing a clearance height of the power machine with the lift arm structure in a fully-lowered position. In addition, some lift arm structures according to the disclosure allow for an implement supported by a lift arm to be moved, relative to a frame of a power machine, to any position with a lift envelope of the lift arm (e.g., a two-dimensional envelope from a side elevation perspective), including upwards, downwards, and front-to-back movement. For example, actuators of a lift arm structure can be arranged to move the lift arm in an extension-retraction dimension and in a raise-lower dimension, collectively or independently.

According to some aspects of the disclosure, a loader can include a main frame, tractive elements supported by the main frame, and a lift arm structure coupled to the main frame and moveable between a fully-lowered position and a fully-raised position. The lift arm structure can include a lift arm, a connecting link, a lift actuator, and an extension actuator. The lift arm can have a first end positioned forward of a second end (e.g., forward as defined by a front to back axis of the main frame relative to tractive movement, or as defined by an extension direction of the lift arm from fully retracted to fully extended), when the lift arm is in the fully-lowered position. The first end of the lift arm can define a pivot connection for an implement. A connecting link can have a first end pivotally coupled to the main frame at a connecting link pivot point, and a second end pivotally coupled at the second end of the lift arm at a lift arm pivot point. The lift actuator can be configured to pivot the lift arm about the lift arm pivot point relative to the main frame and the connecting link. The extension actuator can be configured to pivot the connecting link about the connecting link pivot point to move the connecting link and the lift arm relative to the main frame.

In some examples, the lift actuator can be pivotally coupled at a first end to one of the main frame or the connecting link, and at a second end to the lift arm. The lift actuator can be configured to move between a retracted position and an extended position to pivot the lift arm about the lift arm pivot point to move the implement relative to the main frame. The extension actuator can be pivotally coupled at a first end to the main frame and pivotally coupled at a second end to the connecting link. The extension actuator can be configured to move between a retracted position and an extended position to pivot the connecting link about the connecting link pivot point and thereby move the lift arm relative to the main frame.

In some examples, the connecting link pivot point can be at a lower height on the main frame than one or more of the first end of the lift actuator or the first end of the extension actuator.

In some examples, the first end of the lift actuator can be positioned forward of the second end of the lift actuator and rearward of the second end of the lift actuator.

In some examples, the first end of the extension actuator can be positioned at a lower height and in front of the first end of the lift actuator.

In some examples, relative to a vertical direction, the second end of the extension actuator can be at a lower height than the second end of the lift actuator for any position of the lift arm structure between the fully-lowered position and the fully-raised position.

In some examples, with the lift arm in the fully-lowered position, the first end of the lift actuator and the first end of the extension actuator can be pivotally secured to the frame at below the lift arm.

In some examples, the second end of the extension actuator can be positioned rearward of the second end of the lift actuator when the lift arm is in the fully-lowered position.

In some examples, the lift arm structure can further include a tilt system configured to pivot the implement about the pivot connection. The tilt system can include a tilt actuator configured to extend and retract to cause the implement to rotate relative to the lift arm.

According to some aspects of the disclosure, a loader can include: a main frame, a lift arm structure, and a control system. The lift arm structure can be coupled to the main frame and moveable between a fully-lowered position and a fully-raised position. The lift arm structure can include a lift arm pivotally supported relative to the main frame and actuators arranged to move the lift arm structure between the fully-lowered and fully-raised positions. The control system can include an electronic controller configured to receive command inputs that indicate target movements of the lift arm and to provide corresponding outputs to control the one or more actuators. The electronic controller can be configured to selectively operate in a radial lift mode, in which the control system controls the actuators based on the command inputs to move the lift arm along a radial lift path, and in a non-radial lift mode, in which the control system controls the actuators based on the command inputs to move the lift arm along a non-radial lift path.

In some examples, the lift arm can include an implement pivot point at a first end that can be configured to support an implement. The lift arm structure can include a connecting link that pivotally supports the lift arm relative to the frame. The actuators can include a lift actuator pivotally secured to the lift arm and an extension actuator pivotally secured to the connecting link. The electronic controller can be configured to control the lift actuator and the extension actuator collectively, to move the implement pivot point of the lift arm to any point within a lift envelope of the lift arm. The lift envelope can be defined by a plurality of bounds that define a volume or area in space relative to the main frame of the loader.

In some examples, a retracted bound can be defined by a first path of the implement pivot point as the lift actuator moves between a fully-extended position and fully-retracted position with the extension actuator at a first extension length.

In some examples, an extended bound can be defined by a second path of the implement pivot point arm as the lift actuator moves between the fully-extended and fully-retracted positions with the extension actuator at a second extension length;

In some examples, a lower bound can be defined by a third path of the implement pivot point as the extension actuator moves between a fully-extended position and a fully-retracted position with the lift actuator at a first lift length.

In some examples, an upper bound can be defined by a fourth path of the lift arm as the extension actuator moves between the fully-extended and fully-retracted positions with the lift actuator at a second lift length.

In some examples, at least part of the retracted bound can be defined with the first extension length of the extension actuator being a minimum arm-extension position of the extension actuator. In some examples, a part of the retracted bound can be defined with the extension actuator at a different position.

In some examples, at least part of the extended bound can be defined with the second extension length of the extension actuator being a maximum arm-extension position of the extension actuator.

In some examples, for a given extension of the lift actuator, movement of the extension actuator between the fully-extended and fully-retracted positions can move the implement pivot point along a corresponding extension path within the lift envelope. Different extensions of the lift actuator can provide different curvature, respectively, for the corresponding extension paths (e.g., a first curvature for a first lift actuator length, a second curvature for a second lift actuator length, etc.).

In some examples, for a given extension of the extension actuator, movement of the lift actuator between the fully-extended and fully-retracted positions can move the implement pivot point along a corresponding lift path within the lift envelope. Different extensions of the extension actuator can provide different curvature, respectively, for the corresponding lift paths (e.g., a first curvature for a first extension actuator length, a second curvature for a second extension actuator length, etc.).

In some examples, the electronic control system can be configured to restrict movement of the implement pivot point to an operational envelope within the lift envelope (e.g., smaller along multiple bounds than the operational enveloper).

In some examples, the electronic control system can be configured to control the lift actuator and the extension actuator concurrently to selectively move the implement pivot point along a vertical direction and along a horizontal direction.

Some aspects of the invention can provide a method of operating a loader. Command inputs can be received that indicate target movements of a lift arm. The lift arm can be pivotally supported relative to a main frame of the power machine and can be included in a lift arm structure that further includes actuators arranged to move the lift arm structure between a fully-lowered position and fully-raised position. The actuators can be selectively controlled in a radial lift mode and a non-radial lift mode. In a radial lift mode, the actuators can be controlled based on the command inputs to move the lift arm along a radial lift path. In a non-radial lift mode, the actuators can be controlled based on the command inputs to move the lift arm along a non-radial lift path.

In some examples, the lift arm structure can further include a connecting link pivotally coupled to a main frame of the power machine and to the lift arm to pivotally support the lift arm relative to the main frame.

In some examples, the actuators can include a lift actuator pivotally coupled to the lift arm and an extension actuator pivotally coupled to the connecting link. Selectively controlling the actuators can include (e.g., in one or more radial or non-radial lift modes): moving the lift actuator between a retracted position and an extended position to pivot the lift arm relative to the connecting link; and moving the extension actuator between a retracted position and an extended position to pivot the connecting link relative to the main frame.

In some examples, a power machine can include a frame and a lift arm that is movably coupled relative to the frame. In particular, the lift arm can be configured to move the implement to any point within a lift envelope, which may include upward, downward, or front-to-back movement of the implement, relative to the frame. To cause this movement, a lift arm can be pivotally coupled to a connecting link, which in turn, can be pivotally coupled to the frame. An extension actuator can extend between the frame and the connecting link and a lift actuator can extend between the frame and the lift arm, so that coordinated operation of one or both of the extension and lift actuators can move the lift arm to position the implement within the lift envelope.

According to some aspects of the disclosure, a loader can include a main frame having a front end opposite a rear end, and a lift arm structure coupled to the main frame. The lift arm structure can be moveable between a fully-lowered position and a fully-raised position (inclusive). The lift arm structure can include a lift arm and a connecting link. The lift arm can have a first end positioned forward of a second end when the lift arm is in the fully-lowered position. The connecting link can have a first end pivotally coupled to the main frame at a connecting link pivot point, and a second end pivotally coupled at the second end of the lift arm to define a lift arm pivot point. The lift arm structure can further include a lift actuator that can be pivotally coupled at a first end to the main frame and pivotally coupled at a second end to the lift arm. The lift actuator can be configured to move between a retracted position and an extended position to pivot the lift arm about the lift arm pivot point in order to move the lift arm relative to the main frame and the connecting link. The lift arm structure can further include an extension actuator that can be pivotally coupled at a first end to the main frame and pivotally coupled at a second end to the connecting link (e.g., between the first end and the second end). The extension actuator can be configured to move between a retracted position and an extended position to pivot the connecting link about the connecting link pivot point and thereby move the lift arm relative to the main frame.

According to some aspects of the disclosure, a loader can include a main frame having a front end opposite a rear end, and a lift arm structure coupled to the main frame. The lift arm structure can be moveable between a fully-lowered position and a fully-raised position (inclusive). The lift arm structure can include a lift arm and a connecting link. The lift arm can have a first end positioned forward of a second end when the lift arm is in the fully-lowered position The first end of the lift arm can define a pivot connection. The connecting link can have a first end pivotally coupled to the main frame at a connecting link pivot point, and a second end pivotally coupled at the second end of the lift arm to define a lift arm pivot point. The lift arm structure can further include a lift actuator configured to pivot the lift arm about the lift arm pivot point relative to the main frame; and an extension actuator configured to pivot the connecting link about the connecting link pivot point (e.g., to move the lift arm relative to the main frame).

According to some aspects of the disclosure, a lift arm structure is provided, which can be configured to be operatively supported on a loader having a main frame. The lift arm structure can include a lift arm having a first end and a second end, and a connecting link. The connecting link can have a first end pivotally coupled to the main frame at a connecting link pivot point, and a second end pivotally coupled at the second end of the lift arm to define a lift arm pivot point. The lift arm structure can further include lift actuator that can be configured to pivot the lift arm about the lift arm pivot point relative to the connecting link and an extension actuator that can be configured to pivot the connecting link about the connecting link pivot point (e.g., to move the lift arm relative to the main frame). The lift arm structure can further include a control system with an electronic controller configured to receive an input that indicates a target movement of the lift arm and to control the lift actuator and the extension actuator collectively to move the first end of the lift arm to any point within a lift envelope. The lift envelope can be defined by an inboard bound, an outboard bound, a lower bound and an upper bound. The inboard bound can be defined by a first path of the lift arm as the lift actuator moves between a fully-extended position and fully-retracted position (inclusive). The outboard bound can be defined by a second path of the lift arm as the lift actuator moves between the fully-extended and fully-retracted positions (inclusive). The lower bound can be defined by a third path of the lift arm as the extension actuator moves between a fully-extended position and a fully-retracted position (inclusive). The upper bound can be defined by a fourth path of the lift arm as the extension actuator moves between the fully-extended and fully-retracted positions (inclusive).

According to some aspects of the disclosure, a loader can include a main frame having a front end opposite a rear end, and a lift arm structure coupled to the main frame. The lift arm structure can be moveable between a fully-lowered position and a fully-raised position (inclusive). The lift arm structure can include a lift arm and a connecting link. The lift arm can have a first end positioned forward of a second end when the lift arm is in the fully-lowered position. The first end of the lift arm can define a pivot connection. The connecting link can have a first end pivotally coupled to the main frame at a connecting link pivot point, and a second end pivotally coupled at the second end of the lift arm to define a lift arm pivot point. A lift actuator can be configured to pivot the lift arm about the lift arm pivot point relative to the main frame. An extension actuator can be configured to pivot the connecting link about the connecting link pivot point to move the first end of the lift arm between a minimum arm-extension position that is closest to the frame and a maximum arm-extension position that is furthest from the frame. The minimum arm-extension position of the extension actuator can be one of a fully-extended position or a fully-retracted position of the extension actuator and the maximum arm-extension position of the extension actuator can be the other of the fully-retracted position or the fully-extended position of the extension actuator.

According to some aspects of the disclosure, a loader can include a main frame having a front end opposite a rear end, and a lift arm structure coupled to the main frame. The lift arm structure can be moveable between a fully-lowered position and a fully-raised position (inclusive). The lift arm structure can include a lift arm and a connecting link. The lift arm can have a first end positioned forward of a second end when the lift arm is in the fully-lowered position. The first end of the lift arm can be configured to operatively couple to an implement carrier at an implement carrier pivot point. The connecting link can have a first end pivotally coupled to the main frame at a connecting link pivot point and a second end pivotally coupled at the second end of the lift arm to define a lift arm pivot point. The lift arm pivot point can be positioned rearward of the connecting link pivot point in both the fully-lowered position and the fully-raised position. A lift actuator can be configured to pivot the lift arm about the lift arm pivot point to move the implement carrier relative to the main frame. An extension actuator can be configured to pivot the connecting link about the connecting link pivot point and move the lift arm and the implement carrier relative to the main frame.

The loader can further include a tilt system that can be configured to pivot the implement carrier about the implement carrier pivot point. The tilt system can include a rocker link, a tilt link, and a tilt actuator. The rocker link can include a first pivot point, a second pivot point, and a third pivot point. The rocker link can be pivotally coupled to the lift arm at the first pivot point. The tilt link can have a first end pivotally coupled to the rocker link at the second pivot point and a second end pivotally coupled to one of the implement carrier or the lift arm. The tilt actuator can have a first end pivotally coupled to the other of the implement carrier or the lift arm and a second end pivotally coupled to the rocker link at the third pivot point. The tilt actuator can be configured to extend and retract to pivot the rocker link about the first pivot point. The pivoting of the rocker link can cause the implement carrier to rotate about the implement carrier pivot point via the tilt link.

According to some aspects of the disclosure, a loader can include a main frame having a front end opposite a rear end, and a lift arm structure coupled to the main frame. The lift arm structure can be moveable between a fully-lowered position and a fully-raised position (inclusive). The lift arm structure can include a lift arm and a connecting link. The lift arm can have a first end positioned forward of a second end when the lift arm is in the fully-lowered position The first end of the lift arm can be configured to operatively couple to an implement carrier. The connecting link can have a first end pivotally coupled to the main frame at a connecting link pivot point and a second end pivotally coupled to the second end of the lift arm to define a lift arm pivot point. The lift arm structure can further include a lift actuator and an extension actuator. The lift actuator can be pivotally coupled at a first end to one of the main frame or the connecting link, and at a second end to the lift arm. The lift actuator can be configured to move between a retracted position and an extended position to pivot the lift arm about the lift arm pivot point to move the implement carrier relative to the main frame. The extension actuator can be pivotally coupled at a first end to the main frame and pivotally coupled at a second end to the connecting link. The extension actuator can be configured to move between a retracted position and an extended position to pivot the connecting link about the connecting link pivot point and to move the lift arm and the implement carrier relative to the main frame.

According to some aspects of the disclosure, a loader can include a main frame, a lift arm structure, and a control system. The lift arm structure can be coupled to the main frame and moveable between a fully-lowered position and a fully-raised position, inclusive, the lift arm structure including a lift arm pivotally supported relative to the main frame and one or more actuators arranged to move the lift arm structure between the fully-lowered and fully-raised positions. The control system can include an electronic controller configured to: receive inputs that indicates target movements of the lift arm, and provide corresponding outputs to control the one or more actuators. The electronic controller can be configured to, in response to a first operator input, selectively operate in either of a radial lift mode, in which the control system controls the one or more actuators based on the first operator input to move the lift arm along a radial lift path, and a non-radial lift mode, in which the control system controls the one or more actuators to move the lift arm along a non-radial lift path.

According to some aspects of the disclosure, a loader can include a main frame, a power source supported by the main frame, a tractive assembly that supports the main frame and is powered by the power source, and a lift arm structure. The lift arm structure can be coupled to the main frame and moveable between a fully-lowered position and a fully-raised position, inclusive, the lift arm structure including a lift arm pivotally supported relative to the main frame and one or more actuators arranged to move the lift arm structure between the fully-lowered and fully-raised positions. The lift arm structure (e.g., the lift arm) can extend along at least one (e.g., two opposed) lateral side of the main frame from a back of the main frame to a front of the main frame. The main frame can not include an operator station for a human operator (i.e., can include no such operator station).

This Summary and the Abstract are provided to introduce a selection of concepts in a simplified form that are further described below in the Detailed Description. This Summary is not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which embodiments of the present disclosure can be advantageously practiced.

FIGS. 2-3 illustrate perspective views of a representative power machine in the form of a tracked loader of the type on which the disclosed embodiments can be practiced.

FIG. 4 is a block diagram illustrating components of a power system of a loader such as the loader illustrated in FIGS. 2-3.

FIG. 5 is a front, right, and top perspective view of a loader including a lift arm structure that is operatively supported on a frame, according to aspects of the disclosure.

FIG. 6 is a front, left, and top perspective view of the loader of FIG. 5.

FIG. 7 is a top plan view of the loader of FIGS.

FIG. 8 is a right side elevational view of the loader of FIG. 5, including schematically illustrated alternative actuator arrangements for lift arm structures.

FIG. 9 is a rear, right, and top perspective view of the loader of FIG. 5, with a lift arm removed to show actuators that are configured to move the lift arm relative to the frame.

FIG. 10 is a partial schematic and cross-sectional view of the loader of FIG. 5, taken through line 10-10 in FIG. 7.

FIG. 11 is a perspective view of an actuator for the lift arm structure.

FIG. 12 is a schematic view illustrating a lift envelope of the loader of FIG. 5.

FIG. 13 is a schematic view illustrating certain alignments of pivot joints of a lift arm according to aspects of the disclosure.

FIG. 14 is a front, right, and top perspective view of another configuration of the loader of FIG. 5, including a lift arm structure with a bridge structure, according to aspects of the disclosure.

FIG. 15 is a cross-sectional view of the loader of FIG. 14, taken through a centerline sagittal plane of the loader.

FIG. 16 is a top side cross-sectional view of the bridge structure of FIG. 14, taken along a plane parallel with a top surface of a lift arm of the loader, through pivoting joint between the bridge structure and two lift actuators of the loader.

FIG. 17 is another top side cross-sectional view of the bridge structure of FIG. 14, taken along a horizontal plane through the pivoting joints between the bridge structure and a tilt actuator of the loader.

FIG. 18 is a top side cross-sectional view of the actuator, taken along a plane parallel with the top surface of the lift arm of the loader, through a pivoting joint between the lift arm and the tilt actuator.

FIG. 19 is a top plan view of the loader of FIG. 14, with a detail cross-section view taken along a horizontal plane through a pivoting joint between the lift arm and inboard and outboard support plates of a connecting link.

FIG. 20 is a top side cross-sectional view of the loader of FIG. 14, showing the pivoting joints between the lift arm and the inboard and outboard support plates of FIG. 19, taken along a plane parallel with a top surface of the lift arm of the loader.

FIG. 21 is a top side cross-sectional view of the loader of FIG. 14, taken along a plane parallel with a top surface of a lift arm of the loader, through a torsion member of the lift arm structure.

FIG. 22 is a top plan cross-sectional view of the loader of FIG. 14, taken along the sectional plane of FIG. 21, with a detail horizontal cross-sectional view showing a pivoting joint between the connecting link and the frame.

FIG. 23 is a front, top isometric view of an example multi-piece frame of the loader of FIG. 14 including a bridge frame and a base frame.

FIG. 24 is a bottom, front perspective view of the frame of FIG. 23.

FIG. 25 is a rear, top isometric view of the bridge frame.

FIG. 26 is a rear, bottom isometric view of the bridge frame of FIG. 25.

FIG. 27 is a top, front isometric view of the base frame.

FIG. 28 is a cross-sectional view of the frame of FIG. 23, taken along a vertical plane through the frame between a first side box structure and a central tower.

FIG. 29 is a cross-sectional view of the frame of FIG. 23, taken along a vertical plane through a drive sprocket axis that extends between the first side box structure and a second side box structure.

FIG. 30 is a cross-sectional view of the frame of FIG. 23, taken along a vertical plane through the frame between the first side box structure and an outboard sidewall of a battery assembly.

FIG. 31 is a rear, bottom, right isometric view of the loader of FIG. 14, with the base frame and power source removed.

### DETAILED DESCRIPTION

Before any embodiments of the disclosure are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings unless identified as such.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations. In some cases, reference to a front of a power machine can refer in particular to a side of a power machine at which an implement (e.g., a bucket) is located when the implement is in a fully-lowered or other rest position. Correspondingly, in some cases, a forward direction can indicate a direction toward that particular side.

As also as used herein, unless otherwise limited or defined, “substantially parallel” indicates a direction that is within ±12 degrees of a reference direction (e.g., within ±6 degrees or ±3 degrees), inclusive. Correspondingly, “substantially vertical” indicates a direction that is substantially parallel to the vertical direction, as defined relative to the reference system (e.g., for a power machine, as defined relative to a horizontal support surface on which the power machine is operationally situated), with a similarly derived meaning also for “substantially horizontal.” “Substantially non-horizontal” indicates a direction that is not substantially parallel to the horizontal direction, as defined relative to the reference frame. For a power machine, in particular, horizontal is defined relative to a horizontal support surface on which the power machine is operationally situated. A path that is not linear is substantially parallel to a reference direction if a straight line between end-points of the path is substantially parallel to the reference direction or a mean derivative (i.e., mean local slope) of the path within a common reference frame as the reference direction is substantially parallel to the reference direction.

The present disclosure provides for improved lift arm structures that can allow an end of a lift arm (e.g., an end configured to support an implement relative to a frame), to be moved along a variety of travel paths within a lift envelope, between a fully-raised position and a fully-lowered position. Correspondingly, an operative feature of the lift arm (e.g., an end of the lift arm configured to operatively support an implement) can be positioned at any point within the lift envelope and can allow for a greater maximum lift height (e.g., a maximum height of an implement relative to a support surface, for example, the ground), as compared to conventional designs. Further, some examples can achieve these or other improved aspects of lift arm operation while also maintaining or reducing a clearance height of the power machine (i.e., a maximum height of the power machine with the lift arm in a fully-lowered position).

Generally, lift arm structures as disclosed herein can include multi-member lift arm structures, with multiple actuators that can separately and cooperatively move links of the multi-member structure. As a result, more useful and more extensive lift arm movements can be executed than may be possible with conventional designs.

For example, some lift arm structures according to the present disclosure can include a lift arm and a connecting link that are supported by and configured to move relative to the frame. More specifically, the lift arm can extend (e.g., in a back-to-front direction) from a first end that can be pivotally coupled to the connecting link at a lift arm pivot point, to a second end that can be configured to operatively couple to an implement (e.g., via an implement carrier at an implement carrier pivot point). The lift arm can be pivoted about the lift arm pivot point between a lowered position (e.g., a minimum elevation position) and a raised position (e.g., a maximum elevation position). Movement of the lift arm can cause the lift arm (e.g., the second end of the lift arm) to move along a travel path (e.g., an arcuate lift path) to move in a substantially vertical direction. The specific shape of the travel path may vary depending on a front-to-back position of the lift arm relative to the frame.

Continuing, a first end of the connecting link can be pivotally coupled to the frame (e.g., at a rear end thereof) at a connecting link pivot point and a second end of the connecting link can be pivotally coupled to the lift arm at the lift arm pivot point. The connecting link can be pivoted about the connecting link pivot point to move the lift arm generally in a front-to-back direction between a forward position (e.g., an extended position) and a rearward position (e.g., a retracted position). Accordingly, pivotal movement of the connecting link can move the lift arm (e.g., the second end of the lift arm) along a travel path (e.g., an extension path). The particular shape of the travel path caused by movement of the connecting link may vary depending on the position of the lift arm between the lowered position and the raised position, but may generally induce some front-to-back and up-and-down (e.g., a combination of vertical and horizontal) movement of the second end of the lift arm.

Movement of a lift arm and a connecting link about their respective pivot points in such an arrangement can be facilitated by the extension and retraction of actuators (e.g., electrical actuators). For example, a lift actuator can be pivotally coupled at a first end to a frame of a power machine and pivotally coupled at a second end to a lift arm (e.g., between a first end and a second end of the lift arm). The lift actuator can move between a fully-retracted position (e.g., a minimum extension position) and a fully-extended position (e.g., a maximum extension position) to pivot the lift arm between the lowered position and the raised position. For example, the lift arm can be in the lowered position when the lift actuator is in the fully-retracted position and in the raised position when the lift actuator is in the fully-extended position. Similarly, an extension actuator can be pivotally coupled at a first end to a frame of a power machine and pivotally coupled at a second end to a connecting link. Depending on the relative (e.g., front-to-back) positions of the extension actuator and the connecting link, the connecting link can be in the fully-forward position when the extension actuator is in the fully-retracted position and in the fully-rearward position when the lift actuator is in the fully-extended position, or vice versa. In some cases, extension and lift actuators can be arranged so that lines extending between the first and second ends of each actuator, as geometrically projected onto a vertical center plane of the power machine that extends along a front to rear direction, do not intersect each other for any position of the range of positions of the lift arm structure.

In accordance with the relative pivotal movements of the lift arm and the connecting link, a lift envelope of a lift arm structure can have a curved, generally four-sided shape. In particular, the lift envelope can be defined by a rearward (or retracted) bound, a forward (or extended) bound, a lower bound, and an upper bound, as can be defined by different combinations of actuator orientations. In some cases, the rearward bound can be defined by a first path of the lift arm, defined by moving the lift actuator between the fully-extended position and fully-retracted positions (e.g., to move the lift arm between the lowered and raised positions), with the connecting link in the fully-rearward position. In some cases, the forward bound can be defined by a second path of the lift arm, defined by moving the lift actuator between the fully-extended and fully-retracted positions (e.g., to move the lift arm between the lowered and raised positions), with the connecting link in the fully-forward position. In some cases, the lower bound can be defined by a third path of the lift arm, defined by moving the extension actuator between the fully-extended position and fully-retracted positions (e.g., to move the lift arm between the retracted and extended positions), with the lift arm in the lowered position. In some cases, the upper bound can be defined by a fourth path of the lift arm, defined by moving the extension actuator between the fully-extended position and fully-retracted positions (e.g., to move the lift arm between the retracted and extended positions), with the lift arm in the raised position.

In some embodiments, a fully-raised position of the lift arm structure may correspond with the lift arm being positioned at the fully-raised and fully-extended positions, and the fully-lowered position of the lift arm structure may correspond with the lift arm being positioned at the fully-lowered and fully-retracted positions. In other embodiments, the fully-lowered or fully-raised positions of the lift arm structure may be different. Similarly, although travel over a full lift envelop may be possible for a particular linkage and actuator arrangement of some examples, limitations on such travel may be imposed in some cases (e.g., by a controller limiting a range of motion of one or more actuators). For example, to prevent potential contact with a lift arm, or an implement supported by the lift arm, an actuator of a lift arm may not be fully retracted despite a command to fully lower the lift arm. Accordingly, a lift arm structure may be configured to move within an operational envelope (e.g., that is smaller than a lift envelope).

In some cases, a controller (e.g., an electronic controller) can be provided to control movement along a variety of types of travel paths within a lift envelope (e.g., an operational envelope). The controller can be configured to receive an input (e.g., an operator input) that indicates a target movement of the lift arm and to control the lift actuator and the extension actuator collectively to move the lift arm to any point within a lift envelope (e.g., along a calculated travel path between a start point and an end point). Correspondingly, travel paths can include any of (primarily) upward, downward, or front-to-back movement of the end of the lift arm, relative to the frame of the power machine. In some cases, the travel paths can be substantially straight (e.g., vertical or horizontal), or they can be curved. In that regard, in some embodiments, a controller can include a lockout function to limit movement of the lift arm along a travel path (e.g., a lift path) defined by fully extending the lift actuator at a given extension of the extension actuator, or along a travel path (e.g., an extension path) defined by fully extending and retracting the extension actuator at a given extension of the lift actuator. In some embodiments, a controller can be configured to operate in a cartesian mode, in which the lift and extension actuators can be simultaneously controlled to cause, for example, purely vertical or purely horizontal movement of the lift arm, relative to the frame of the loader.

In some embodiments, a lift arm structure can include a tilt system configured to adjust an attitude of an implement (e.g., an implement carrier) relative to a lift arm. For example, a lift arm structure can include an implement carrier configured to support an implement on the lift arm, which can be pivotally coupled to a second end of the lift arm at an implement carrier pivot point. To pivot the implement carrier, the tilt system can be configured as a bell-crank system that includes a rocker link defining first, second, and third pivot points. The rocker link can be pivotally coupled to the lift arm at the first pivot point. A tilt link can extend between the rocker link and the implement carrier, with a first end of the tilt link pivotally coupled to the rocker link at the second pivot point and a second end of the tilt link pivotally coupled to the implement carrier. A tilt actuator can extend between the rocker link and the lift arm, with a first end of the tilt actuator pivotally coupled to the lift arm and a second end pivotally coupled to the rocker link at the third pivot point. Thus, actuation of the tilt actuator can change an attitude of an implement via driven movement of the rocker link and the tilt link.

In some embodiments, the positions of a tilt link and a tilt actuator can be swapped, for example, so that a tilt actuator extends between the rocker link and the implement carrier and so that a tilt link extends between the rocker link and the lift arm. In either case, the tilt actuator can be configured to move between a fully-extended and fully-retracted position to pivot the implement carrier about the implement carrier pivot point.

In some embodiments, it can be advantageous to position a tilt system generally above a lift arm, as may increase clearance below the lift arm, for example, to accommodate any lift or extension actuators. Additionally, where the tilt link extends between the rocker link and the lift arm, positioning a tilt system generally above a lift arm can help to protect a tilt actuator from damage during operation. For example, in a fully-lowered position of the lift arm structure, a tilt actuator can be positioned generally above and rearward of the other components of the tilt system, so that the rocker link and tilt link extend between the tilt actuator and the implement carrier. Additionally, in some cases, with the lift arm structure fully-lowered, the tilt actuator can be oriented (e.g., to be substantially horizontal) so that an extension axis of the tilt actuator is oriented so as not to intersect the implement carrier for any position of the lift arm structure.

As noted above and further discussed below, some embodiments may be particularly suitable for implementation on a mini-loader. As used herein, “mini-loader” refers to a power machine that is smaller than traditional compact construction equipment. A specific form of mini-loader includes an operator station that is located at or near a rear portion of the loader and that can be accessed from the rear of the loader. More specifically, mini-loaders often do not have cabs or operator compartments where an operator can sit while operating the loader.

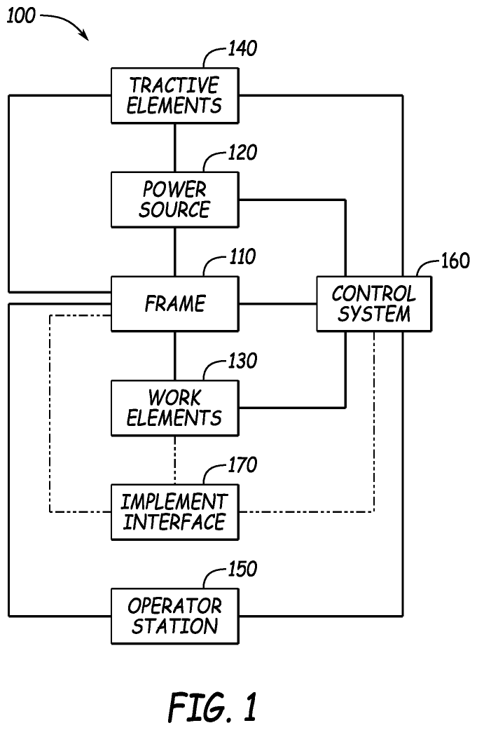

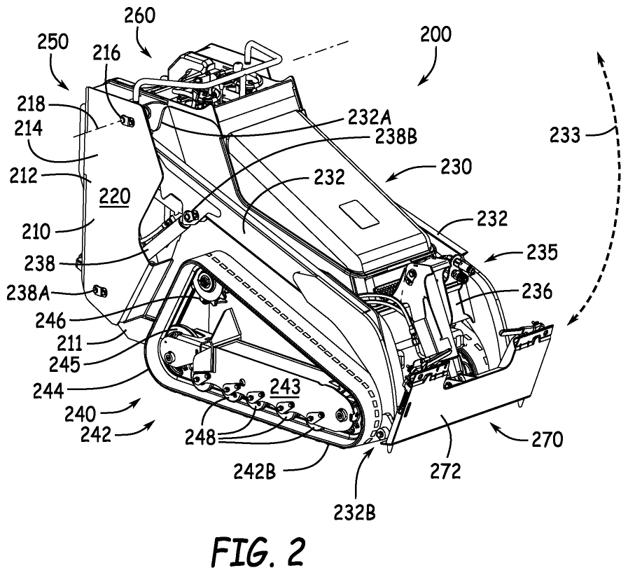

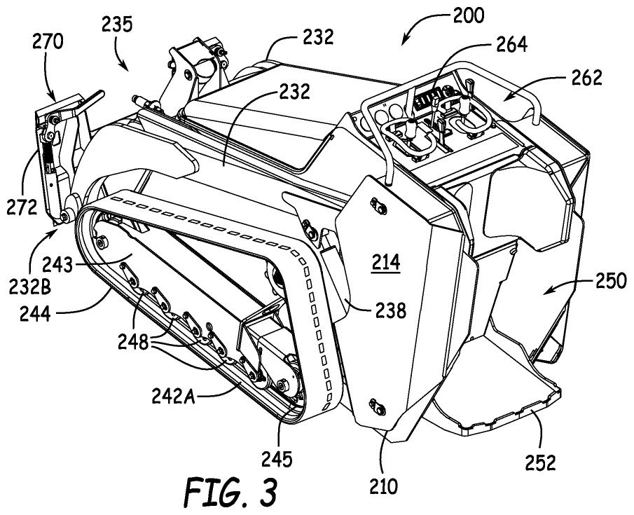

The concepts described herein can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is illustrated and discussed as being a representative power machine. However, as mentioned above, the embodiments below can potentially be practiced on any of a number of power machines, possibly including power machines of different types from the representative power machine shown in FIGS. 2-3. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power. Some embodiments disclosed herein can be practiced particularly advantageously on power machines configured as mini-loaders. In particular, some embodiment can be practiced particularly advantageously on cabless mini-loaders (e.g., mini-loaders without an operator station or platform), including remotely-operated, or semi- or fully-autonomous mini loaders, which can be configured to operatively support a variety of implements on a lift arm.

FIG. 1 is a block diagram that illustrates the basic systems of a power machine 100, which represents any of a number of different types of power machines upon which the embodiments discussed below can be advantageously incorporated. The block diagram of FIG. 1 identifies various systems on the power machine 100 and the relationship between various components and systems. As mentioned above, at the most basic level, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator. For example, the control system 160 can be an integrated or distributed architecture of one or more processor devices and one or more memories that are collectively configured to receive operator input or other input signals (e.g., sensor data) and to output commands accordingly for power machine operations

Certain work vehicles have work elements that can perform a dedicated task. For example, some work vehicles have a lift arm to which an implement such as a bucket is attached such as by a pinning arrangement. The work element (i.e., the lift arm) can be manipulated to position the implement to perform the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of different implements to the work element. One characteristic of such an implement carrier is that once an implement is attached to it, it is fixed to the implement (i.e., not movable with respect to the implement) and when the implement carrier is moved with respect to the work element, the implement moves with the implement carrier. The term implement carrier as used herein is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is configured to provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements that are capable of using it to perform a work function. Power sources for power machines typically include an engine such as an internal combustion engine and a power conversion system such as a mechanical transmission or a hydraulic system that is configured to convert the output from an engine into a form of power that is usable by a work element. Other types of power sources can be incorporated into power machines, including electrical sources alone or in combination with an internal combustion engine. The electrical source can be used to selectively power some or all of the work elements of the power machine and can typically be charged, as necessary, by the internal combustion engine. Such power machines are generally referred to as hybrid power vehicles.

FIG. 1 shows a single work element designated as work element 130, but various power machines can have any number of work elements. Work elements are typically attached to the frame of the power machine and movable with respect to the frame when performing a work task. In some embodiments, as also discussed above, work elements can include lift arm assemblies. In some embodiments, work elements can include mower decks or other similar equipment. In addition, tractive elements 140 are a special case of work elements in that their work function is generally to move the power machine 100 over a support surface. Tractive elements 140 are shown separate from the work element 130 because many power machines have additional work elements besides tractive elements (e.g., lift arms, mower decks, implements, etc.), although that is not always the case. Power machines can have any number of tractive elements, some or all of which can receive power from the power source 120 to propel the power machine 100. Tractive elements can be, for example, track assemblies, wheels attached to an axle, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments or operator positions or not, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both the power machine and any implement to which is it coupled) that can control at least some of the operator-controlled functions on the power machine.

FIGS. 2-3 illustrates a loader 200, which is one particular example of a power machine of the type illustrated in FIG. 1 where the embodiments discussed below can be advantageously employed. Loader 200 is a tracked loader and more particularly, a mini-loader. Consistent with the definition, for the purposes of this discussion, a mini-loader is a small loader relative to other compact loaders such as traditional skid-steer loaders and compact track loaders. As discussed above, specific mini-loaders do not have an operator cab or compartment, but instead can be operated from an operator station located at or near the rear of the loader. The embodiment shown in FIGS. 2-3 is a mini-loader without an operator cab that can be operated from an operator station at the back of the loader. Some mini-loaders have a platform on which an operator can ride on. Other mini-loaders can be operated by an operator who walks behind the loader. Still other mini-loaders have a platform that is moveable or removable to allow an operator to alternatively ride on the platform or walk behind the loader. The loader 200 is an example of a dual-track tracked loader. In some embodiments, these types of mini-loaders can be wheeled loaders as well.

Loader 200 is one particular example of the power machine 100 illustrated broadly in FIG. 1 and discussed above. To that end, features of loader 200 described below include reference numbers that are generally similar to those used in FIG. 1. For example, loader 200 is described below as having a frame 210, just as power machine 100 has a frame 110. Track loader 200 is described herein to provide a reference for understanding one environment on which the embodiments described below related to operator controls may be practiced. The loader 200 should not be considered limiting especially as to features that loader 200 may have described herein that are not essential to the disclosed embodiments. Such features may or may not be included in power machines other than loader 200 upon which the embodiments disclosed below may be advantageously practiced. Unless specifically noted otherwise, embodiments disclosed below can be practiced on a variety of power machines, with the loader 200 being only one of those power machines. For example, some or all of the concepts discussed below can be practiced on many other types of work vehicles such as various other loaders, excavators, trenchers, mowers, and dozers, to name but a few examples.

As mentioned above, loader 200 includes frame 210. Frame 210 supports a power system 220, the power system being configured to generate or otherwise provide power for operating various functions on the power machine. Frame 210 also supports a work element in the form of a lift arm structure 230 that is selectively powered by the power system 220 in response to signals from an operator control system 260 and can perform various work tasks. As loader 200 is a work vehicle, frame 210 also supports a traction system 240, which is also selectively powered by power system 220 in response to signals from operator control system 260. The traction system 240 is configured to propel the power machine over a support surface. The lift arm structure 230 in turn supports an implement carrier 272, which is configured to receive and secure various implements to the loader 200 for performing various work tasks. The loader 200 can be operated from an operator station 250 from which an operator can manipulate various control devices to cause the power machine to perform various functions, discussed in more detail below. Frame 210 also supports a work element in the form of a lift arm structure 230 that is powered by the power system 220 and can perform various work tasks.

Various power machines that can include or interact with the structures or functions of embodiments discussed below can have various frame components that support various work elements. The elements of frame 210 discussed herein are provided for illustrative purposes and are not necessarily the only type of frame that a power machine on which the embodiments discussed below can be practiced and can be employed, unless otherwise specifically indicated. Frame 210 of loader 200 includes an undercarriage or lower portion 211 of the frame and a mainframe or upper portion 212 of the frame that is supported by the undercarriage 211. The mainframe 212 of loader 200 is attached to the undercarriage 211 such as with fasteners or by welding the undercarriage 211 to the mainframe 212. Mainframe 212 includes a pair of upright portions 214 located on either side and toward the rear of the mainframe 212 that support a lift arm structure 230 and to which the lift arm structure 230 is pivotally attached. The lift arm structure 230 is illustratively pinned to each of the upright portions 214. The combination of mounting features on the upright portions 214 and the lift arm structure 230 and mounting hardware (including pins used to pin the lift arm structure 230 to the mainframe 212) are collectively referred to as joints 216 (one is located on each of the upright portions 214) for the purposes of this discussion. Joints 216 are aligned along an axis 218 so that the lift arm structure 230 is capable of pivoting, as discussed below, with respect to the frame 210 about axis 218. Other power machines may not include upright portions on either side of the frame or may not have a lift arm structure that is mountable to upright portions on either side and toward the rear of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 210 also supports a pair of tractive elements 242 on either side of the loader 200, which on loader 200 are track assemblies.

The lift arm structure 230 shown in FIGS. 2-3 is one example of a lift arm structure that can be attached to a power machine such as loader 200 or other power machines on which embodiments of the present discussion can be practiced. The lift arm structure 230 has a pair of lift arms 232 that are disposed on opposing sides of the frame 210. A first end 232A of each of the lift arms 232 is pivotally coupled to the power machine at joints 216 and a second end 232B of each of the lift arms is positioned forward of the frame 210 when in a lowered position as shown in FIG. 2. The lift arm structure 230 is moveable (i.e., the lift arm structure 230 can be raised and lowered) under control of the loader 200 with respect to the frame 210. That movement (i.e., the raising and lowering of the lift arm structure 230) is described by a radial travel path, shown generally by arrow 233. For the purposes of this discussion, the travel path 233 of the lift arm structure 230 is defined by the path of movement of the second end 232B of the lift arm structure. Embodiments discussed below may include a vertical path lift arm, which traces a path defined by multiple pivot axes of a multi-bar linkage (e.g. with the second end of the lift arm moving in a substantially vertical direction for at least a portion of the travel path), in contrast to a path defined by a single pivot axis for a radial path lift arm.

The lift arms 232 are each coupled to a cross member 236 that provides increased structural stability to the lift arm structure 230. A pair of actuators 238, which on loader 200 are hydraulic cylinders configured to selectively receive pressurized fluid from power system 220 (shown conceptually as a box in FIG. 2 to represent that it is enclosed within the frame 210), are pivotally coupled to both the frame 210 and the lift arms 234 at pivotable joints 238A and 238B, respectively, on either side of the loader 200. The actuators 238 are sometimes referred to individually and collectively as lift cylinders. Actuation (i.e., extension and retraction) of the actuators 238 cause the lift arm structure 230 to pivot about joints 216 and thereby be raised and lowered along a fixed path illustrated by arrow 233. The lift arm structure 230 shown in FIGS. 2 and 3 is representative of one type of lift arm structure that may be coupled to the power machine 200. Other lift arm structures, with different geometries, components, and arrangements can be pivotally coupled to the loader 200 or other power machines upon which the embodiments discussed herein can be practiced without departing from the scope of the present discussion. For example, other machines can have lift arm structures with lift arms that each has two portions (as opposed to the single piece lift arms 232) that are pivotally coupled to each other along with a control arm to create a four-bar linkage and a substantially vertical travel path or at least more vertical than the radial path of lift arm structure 230. Other lift arm structures can have an extendable or telescoping lift arm. Still other lift arm structures can have several (i.e., more than two) segments or portions. Some lift arms, most notably lift arms on excavators but also possible on loaders, may have portions that are controllable to pivot with respect to another segment instead of moving in concert (i.e., along a pre-determined path) as is the case in the lift arm structure 230 shown in FIGS. 2-3. Some power machines have lift arm structures with a single lift arm, such as is known in excavators or even some loaders and other power machines. Other power machines can have a plurality of lift arm structures, each being independent of the other(s).

An exemplary implement interface 270 is provided at a second end 234B of the arm 234. The implement interface 270 includes an implement carrier 272 that is configured to accept and secure a variety of different implements to the lift arm 230. Such implements have a machine interface that is configured to be engaged with the implement carrier 272. The implement carrier 272 is pivotally mounted to the second end 232B of each of the arms 232. An implement carrier actuator 237 is operably coupled the lift arm structure 230 and the implement carrier 272 and are operable to rotate the implement carrier with respect to the lift arm structure. Other examples of power machines can have a plurality of implement carrier actuators. Still other examples of power machines of the type that can advantageously employ the disclosed embodiments discussed herein may not have a separate implement carrier such as implement carrier 272, but instead may allow only for implements to be directly attached to its lift arm structure such as by pinning.

The implement interface 270 also includes an implement power source 235 available for connection to an implement on the lift arm structure 230. The implement power source 235 includes pressurized hydraulic fluid ports to which an implement can be coupled. The pressurized hydraulic fluid port selectively provides pressurized hydraulic fluid for powering one or more functions or actuators on an implement. The implement power source can, but need not, include an electrical power source for powering electrical actuators or an electronic controller on an implement. The electrical power source can also include electrical conduits that are in communication with a data bus on the loader 200 to allow communication between a controller on an implement and electronic devices on the loader 200. It should be noted that the specific implement power source on loader 200 does not include an electrical power source.

The lower portion 211 of the frame supports and has attached to it a pair of tractive elements, identified in FIGS. 2-3 as left track assembly 242A and right track assembly 242B (collectively tractive elements 242). Each of the tractive elements 242 has a track frame 243 that is coupled to the frame 210. The track frame 243 supports and is surrounded by an endless track 244, which rotates under power to propel the loader 200 over a support surface. Various elements are coupled to or otherwise supported by the track frame 243 for engaging and supporting the endless track 244 and cause it to rotate about the track frame. For example, a sprocket 246 is supported by the track frame 243 and engages the endless track 244 to cause the endless track to rotate about the track frame. An idler 245 is held against the track 244 by a tensioner (not shown) to maintain proper tension on the track. The track frame 243 also supports a plurality of rollers 248, which engage the track and, through the track, the support surface to support and distribute the weight of the loader 200.

An operator station 250 is positioned toward the rear of the frame 210 and is configured to be used by an operator who is behind or on the rear of the frame. A platform 252 is provided for the operator to stand. While standing on the platform 252, and operator has access to a plurality of operator control inputs 262 that, when manipulated by the operator, can provide control signals to control work functions of the power machine 200, including, for example, the traction system 240 and the lift arm 230. Operator control inputs 262 can include joysticks with adjacent reference bars to allow an operator to rest their hand against as they operate the joysticks. In the embodiment shown in FIGS. 2-3, the operator station 250 is open to the back of the power machine 200. Similar other power machines, including other mini-loaders or various other power machines, can include operator stations toward the rear of the respective frames, without necessarily being open to the back of the power machines. Additionally, some power machines (e.g., mini-loaders) may include operator stations toward the rear of a frame, including operator stations that are open to the back of the frame, but without a support (e.g., standing) platform for an operator. For example, some operator stations include controls that can be operated by an operator walking behind the power machine.

In some cases, the various improvements in lift arm configurations and control systems disclosed herein can be particularly beneficial for mini-loaders (e.g., loaders dimensioned to drive through a 36″ doorway and including walk-behind or stand-on operator stations). In particular, some mini-loaders may notably benefit from implementations of the disclosed principles due to the potential for vertically compressed geometry and adaptable lift arm movements. In particular for mini-loaders, some implementations of the disclosed structures may thus provide both increased visibility for rearward-located operators and increased range of operational uses. Thus, for example, some implementations of the disclosed technology can provide mini-loaders (and other power machines) configured for a combination of vertical (or other non-radial) path, radial path, or telehandling lift arm movements (e.g., as part of selectable operational modes). Thus, some implementations can allow operators to execute a beneficial combination of pivoting movement of loads to various lift heights, and substantially horizontal extension at various lift heights).

Display devices 264 are provided in the operator station to give indications of information relatable to the operation of the power machines in a form that can be sensed by an operator, such as, for example audible or visual indications. Audible indications can be made in the form of buzzers, bells, and the like or via verbal communication. Visual indications can be made in the form of graphs, lights, icons, gauges, alphanumeric characters, and the like. Displays can be designed to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

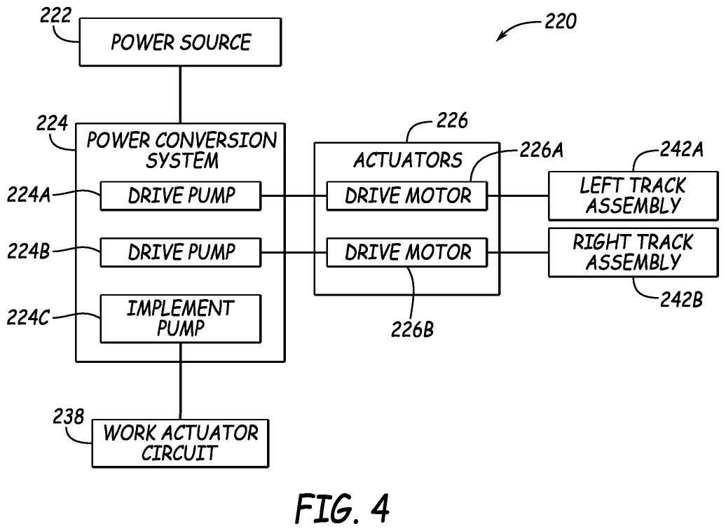

As mentioned above, frame 210 supports and generally encloses the power system 220 so that the various components of the power system 220 are not visible in FIGS. 2-3. FIG. 4 includes, among other things, a diagram of various components of the power system 220. Power system 220 includes one or more power sources 222 that are configured to generate or store power for use on various machine functions. On power machine 200, the power source 222 includes an internal combustion engine. Other power machines can include electric generators, rechargeable or replaceable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, and the like. The power conversion system 224 of power machine 200 includes a pair of hydrostatic drive pumps 224A and 224B, which are selectively controllable to provide a power signal to drive motors 226A and 226B. The drive motors 226A and 226B in turn are each operably connected to tractive elements 242A, 242B, respectively. The drive pumps 224A and 224B can be mechanically, hydraulically, or electrically coupled to operator input devices to receive actuation signals for controlling the drive pumps.

As shown, the power conversion system 224 of power machine 200 also includes a hydraulic implement pump 224C, which is also operably coupled to the power source 222. The hydraulic implement pump 224C is operably coupled to work actuator circuit 238C. Work actuator circuit 238 includes lift cylinders 238 and tilt cylinders 235 as well as control logic to control actuation thereof. The control logic selectively allows, in response to operator inputs, for actuation of the lift cylinders or tilt cylinders. In some machines, the work actuator circuit also includes control logic to selectively provide a pressurized hydraulic fluid to an attached implement. The control logic of power machine 200 includes an open center, 3-spool valve in a series arrangement. The spools are arranged to give priority to the lift cylinders, then the tilt cylinders, and then pressurized fluid to an attached implement.

In other examples, the power conversion system 224 can be otherwise configured. For example, the drive pumps 224A, 224B can be electrically driven (e.g., with the power source 222 as an electric power source). In some cases, the actuators 226 may include electric drive motors (e.g., as the drive motors 226A, 226B) that can be powered by an electric power source 222. Correspondingly, in some examples, the power conversion system 224 may include motor controllers or other components in place of (or in addition to) the drive pumps 224A, 224B. Similarly, the implement pump 224C may in some cases be replaced or supplemented with a motor or other actuator to perform workgroup functions (e.g., lift, tilt, extension, or retraction of lift arms or various implements).

The description of power machine 100 and loader 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a loader such as loader 200, unless otherwise noted or recited, the concepts discussed below are not intended to be limited in their application to the environments specifically described above.

Embodiments of power machines according to the disclosure can provide improved arrangements for lift arm structures that can increase maneuverability and range of motion of the lift arm structure, as compared to conventional lift arm designs, without significant increase to the overall footprint and size of the power machine. In particular, such lift arm arrangements can allow for movement of a lift arm (e.g., an end of a lift arm that is configured to operatively support an implement), along a variety of travel paths (e.g., a lift or extension path), to any position within a lift envelope of the lift arm (e.g., a two-dimensional space bounding the movement of the lift arm). Correspondingly, travel paths can include any direction of movement within the lift envelope, for example, to include any of horizontal, vertical, diagonal, or curvilinear movement of the lift arm.

In some implementations, in response to particular inputs (e.g., operator inputs), a control system of a power machine can control actuators of the power machine to selectively provide a radial path movement of a lift arm or a non-radial path movement of the lift arm, including over part or all of a range of motion of the lift arm (e.g., from a fully-lowered and a fully-raised configuration of a lift arm structure overall). For example, an operator selection or other input can indicate a particular operating mode, and a movement of a lift arm assembly can be controlled correspondingly in response to a particular input command (e.g., with different modes resulting in commands for different relative movement of various actuators in response to the same operator input). As one example in particular, if a radial lift mode is indicated, a controller can selectively command actuators to move lift arms over radial lift paths in response to a first operator input, including if the first operator input does not correspond to a prescribed operator input pattern for a radial lift path (e.g., a straight-line or other prescribed movement pattern at a joystick that corresponds to actuator control for a radial lift command). In contrast, if a non-radial lift mode is indicated, a controller can command actuators to move lift arms over non-radial lift paths in response to an operator input (e.g., the first operator input), at least over part of a range of motion between fully raised and fully lowered orientations.

In this regard, while commanded movement along a non-radial lift path may not be permitted in some radial lift modes, commanded movement along a radial lift path may be possible in some non-radial lift modes. Further, combinations of radial and non-radial lift modes to executed certain operations may be possible in some implementations. In some cases, non-radial lift modes may include temporary operation in a radial lift mode, including as may be started or ended in response to particular operator inputs. For example, in some lift modes, a controller may command actuators to provide a radial lift path movement in response to one or more of: operator inputs that approximate a radial lift path input (e.g., joystick movements that are within a 10% deviation of commands for a prescribed radial lift path input); temporary activation of a button or other toggle; operator inputs corresponding to particular detents; to provide clearance for particular components or operations; or various other factors. In some cases, radial or non-radial lift modes can be implemented relative to particular spatial regions of a lift arm envelope, particular lift heights, particular preprogrammed or adaptive operations, etc. For example, a radial lift arm may be selectively (e.g., automatically) implemented in some cases over part of a path of travel of a lift arm between fully-lowered and fully-raised orientations, along paths at particular radial distances relative to a main frame, or over other spatial regions of a lift envelope of a lift arm.

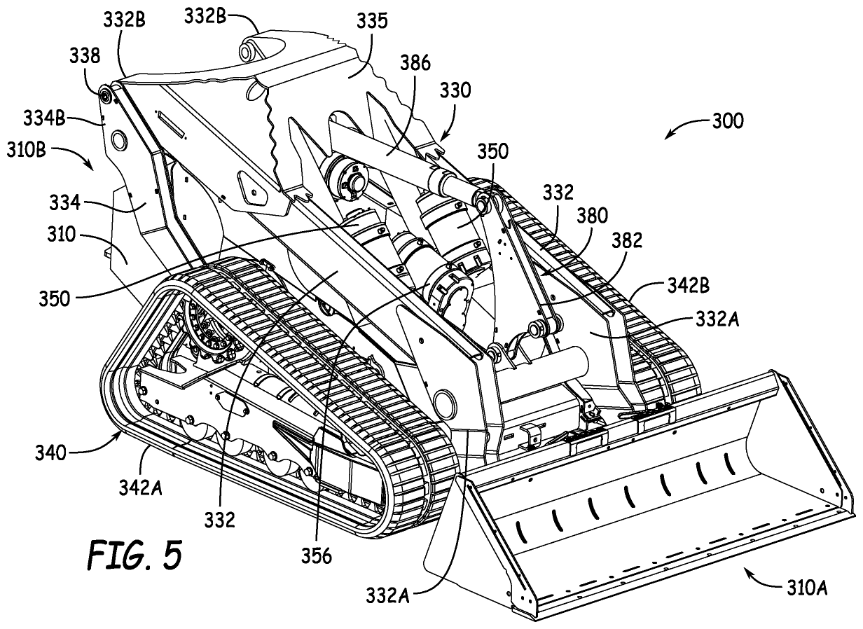

FIGS. 5-10 illustrate a loader 300 (e.g., a mini-loader), which is one particular example of a power machine of the type illustrated in FIG. 1 on which the embodiments discussed herein can be advantageously employed. Similar to the loader 200, the particular illustrated configuration of the loader 300 should not be considered limiting, especially as to the description of features of loader 200 that are not essential to the disclosed embodiments and thus may or may not be included in power machines other than loader 300, upon which the embodiments disclosed below may be advantageously practiced.

Unless specifically noted otherwise, embodiments disclosed below can be practiced on a variety of power machines, with the loader 300 being only one of those power machines. For example, some or all of the concepts discussed below can be practiced on many other types of work vehicles such as various other loaders including compact track loaders and mini-loaders, excavators, trenchers, and dozers, to name but a few examples. In particular, although various electric actuators are discussed below relative to the illustrated lift arm and frame structures of the loader 300, some implementations can instead (or additionally) use one or more hydraulic actuators. For example, some systems may include hydraulic cylinders for lift, tilt, and extension operations, powered by engine- or electrically-driven hydraulic pumps and controlled by various generally known hydraulic control systems (e.g., with a master control valve arranged to control flow of hydraulic fluid to various implement and actuator ports based on the position of a master spool, and with the master spool selectively movable using electrical, mechanical, or hydraulic-pilot commands).

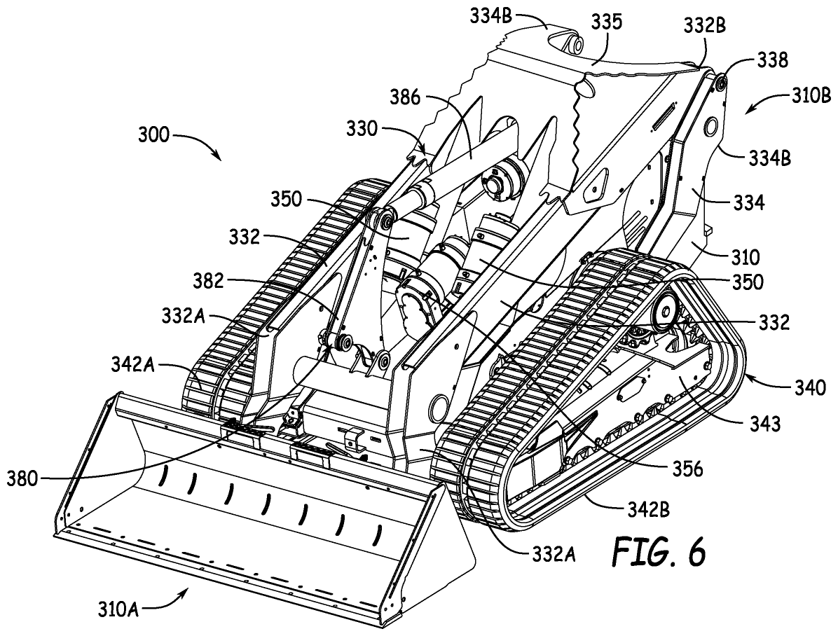

The loader 300 is configured as a tracked loader that is generally similar to the loader 200, with like reference numerals generally referring to like features, unless otherwise indicated. In particular, the loader 300 includes a main frame 310 having a front end 310A opposite a rear end 310B and a right side (see FIG. 5) and a left side (see FIG. 6) extending therebetween. The frame 310 operatively supports a traction system 340 with a pair of tractive elements 342, one at each of the right and left side, to provide tractive power to propel the loader 300 along a support surface (not shown). In addition, the frame 310 is configured to operatively support a lift arm structure 330.

In some cases, the loader 300 can be configured as a remotely operated or at least partially autonomous loader and may not include an operator station (e.g., similar to the operator station 250). For example, as illustrated in FIGS. 5-10, the loader 300 can be a cab-less loader, which is not configured to support an operator. In other cases, the technology disclosed herein can be implemented on power machines that do include cabs or other operator stations.

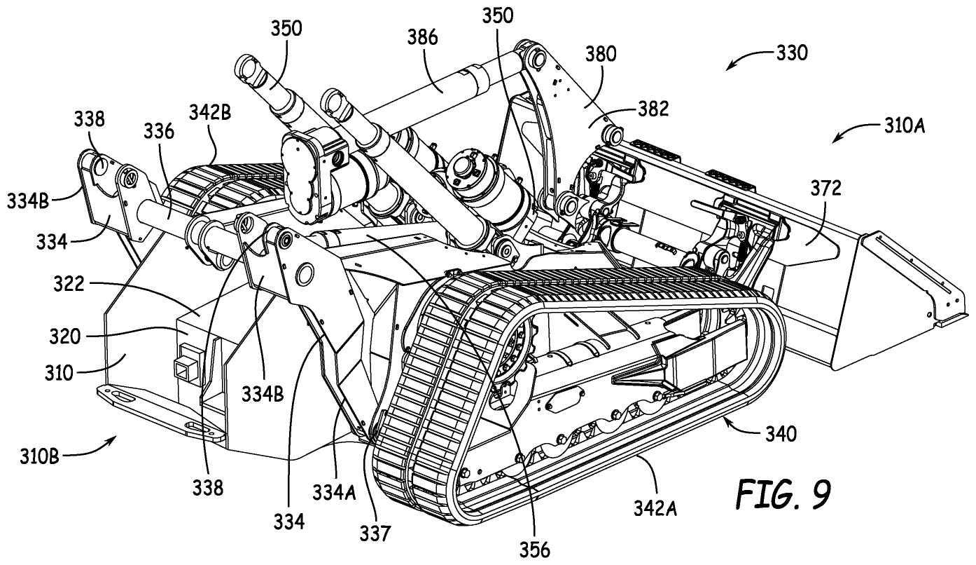

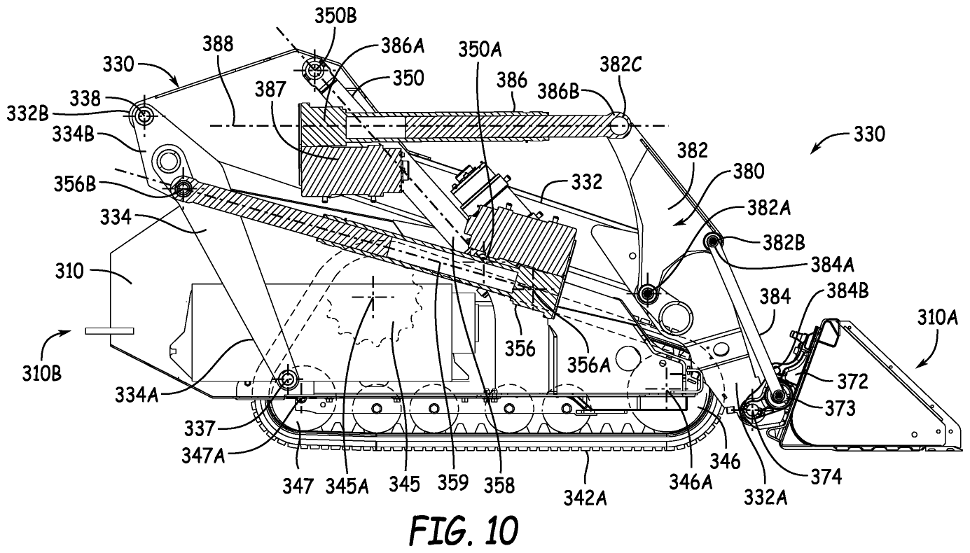

The frame 310 can also be configured to support a variety of other components. For example, similar to the frame 210, the frame 310 can support a power source 320 that can be configured to provide power for executing functions on the loader 300, including operations using the traction system 340 and the lift arm structure 330. In the illustrated embodiment, the power source 320 is an electrical power source, namely, a battery 322 (see FIGS. 9 and 10), which can provide electrical power for operation of the traction system 340, the lift arm structure 330, and other subsystems of the loader 300. The battery 322 can be supported by the frame 310, proximate a rear end 310B of the frame 310, and can include a plurality of battery cells contained by a battery casing. In other embodiments, other power sources (e.g., internal combustion engines) can be used.

As also mentioned above, a lift arm structure according to this disclosure can be configured to provide increased maneuverability and range of motion, as compared to conventional designs. In particular, some lift arm structures can include components that allow a lift arm to move along a variety of differently-shaped travel paths within a larger lift envelope. That is, unlike conventional lift arm structures that are generally configured to move along a single (e.g., substantially vertical) lift path, lift arm structures according to the present disclosure can allow for substantially vertical movement, substantially horizontal movement, or any other direction of movement within a lift envelope of the lift arm, as will be described in greater detail below. Accordingly, in some examples, a lift arm can be moved along any desired path between any two points within the lift envelope.

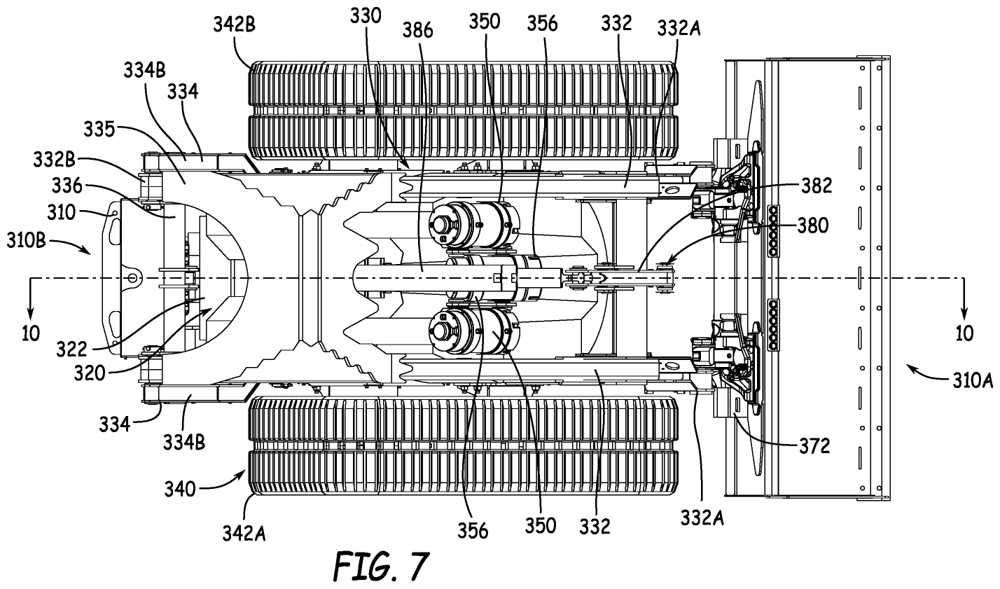

For example, the lift arm structure 330 includes a pair of lift arms 332 and a pair of connecting links 334. The lift arms 332 are coupled to one another by a cross member 336 (see FIGS. 7 and 9) that can provide increased structural stability to the lift arm structure 330, as well as an example bridge structure (as further discussed below) to further increase structural stability and to provide protection to various components of the loader 300. As illustrated, the lift arms 332 are substantially identical to one another, as are the connecting links 334. Accordingly, while only one lift arm 332 and connecting link 334 are discussed below, the discussion equally applies to each of the other lift arm and the other connecting link. However, similar principles can also be applied to other embodiments that only incorporate a single lift arm and connecting link, or that do not have laterally symmetrical lift arm structures (e.g., in contrast to the illustrated example).

The lift arm structure 330 is operatively supported on the frame 310 to move an implement carrier 372 (and a supported implement) relative to the frame 310, although other attachment devices (e.g., integrated pivot points) can be used to support implements in some cases. In the example shown, the lift arm 332 extends generally in a front-to back direction between a first end 332A and a second end 334B. The first end 332A of the lift arm 332 is positioned at the front end 310A of the frame 310 and configured to pivotally couple to the implement carrier 372 at an implement carrier pivot point 374 (or, in other embodiments, an implement pivot point 374 configured for direct or other connection to an implement). The second end 332B of the lift arm 332 is positioned at the rear end 310B of the frame 310 and is configured to pivotally couple to the connecting link 334 so that the lift arm 332 is moveably (pivotally) supported on the frame 310 by the connecting link 334.

Correspondingly, the connecting link 334 extends between the frame 310 and the lift arm 332, from a first end 334A that is configured to pivotally couple to the frame 310, to a second end 334B that is configured to pivotally coupled to the lift arm 332. More specifically, the first end 334A of the connecting link 334 is pivotally coupled to the rear end 310B (e.g., at a lower frame) at a connecting link pivot point 337, and the second end 334B of the connecting link 334 is pivotally coupled to the second end 332A at a lift arm pivot point 338. In some embodiments, the connecting link 334 can be arranged so that the connecting link pivot point 337 is closer to the front end 310A than is the lift arm pivot point 338 for all positions of the connecting link 334, and more generally, all positions of the lift arm structure 330 within a relevant lift (or other operational) envelope. Correspondingly, for all positions of the lift arm structure 330, the connecting link 334 can extend rearward, from a perspective moving along the connecting link 334 from connecting link pivot point 337 to the lift arm pivot point 338.

Due to the various pivotal connections, the lift arm structure 330 can be moved relative to the frame 310 to position the first end 332A of the lift arm 332 (e.g., the implement carrier pivot point 374) and any connected implement carrier 372 or implement, at a desired position within a multi-path lift envelope, relative to the frame 310 (e.g., any desired position within the lift envelope, or any desired position with an operational envelope that is defined by an electronic control system to exclude part of the lift envelope). In particular, to facilitate movement of the lift arm structure, the loader 300 can include actuators (e.g., linear actuators) that can be configured to controllably move either or both of the connecting link 334 and lift arm 332 relative to the frame 310 and to each other. In some embodiments, actuators can be configured as electrical actuators, which may allow for more precise control of the movement of the lift arm structure 330, as compared with conventional hydraulic systems.

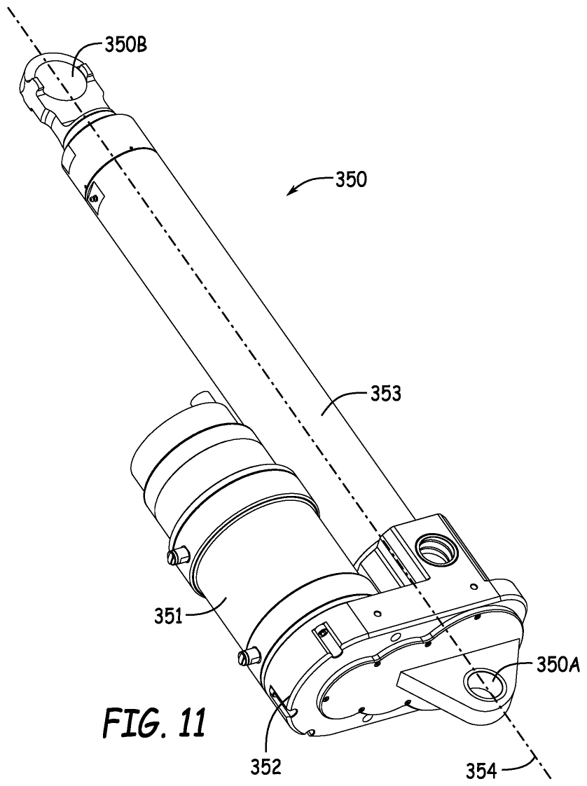

For example, the loader 300 can include a lift actuator 350 (e.g., one for each lift arm 332) that is configured to pivot the lift arm 332 about the lift arm pivot point 338 to move the lift arm 332 relative to the frame 310 and the connecting link 334. With additional reference to FIG. 11, the lift actuator 350 can be configured as an electrically powered ball screw actuator that includes a motor 351 (i.e., an electrical motor) and an extendable portion configured as a ball screw 352, which are operatively connected to one another via a gearbox 353. As illustrated, the lift actuator 350 is in a fold-back motor configuration, in which the motor 351 and the screw 352 extend parallel to one another from the same side of the gearbox 353. The screw 352 defines and extends away from the gearbox 353 along an extension axis 354 and the motor 351 extends parallel to and in the same direction as the screw 352. The screw 375 is configured to linearly extend and retract along the extension axis 354 when powered by the motor 351 via the gearbox 376 to change a distance between a first connection 350A at a first end (e.g., a motor end) of the actuator 350 and a second connection 350B at a second end (e.g., an extension end) of the actuator 350. As will be described in greater detail below, the motor 351 can be controlled by commands from an electronic controller (e.g., in response to an operator input), thereby controlling the extension and retraction of the actuator 350 (e.g., to change an extension length taken along the extension axis 377 between the first connection 350A and the second connection 350B).

In the illustrated example in FIG. 11, the lift actuator 350 is configured as a clevis-mount, fold-back actuator. In other examples, other mounting configurations are possible. For example, as shown in FIGS. 5-10, a lift actuator can be a trunnion-mount, fold-back actuator as can provide reduced actuator a dead-length and other operational and packaging benefits. In still other cases, other known mounting configurations are also possible, and some lift actuators can be configured with in-line motor arrangements, i.e., with the motor extending parallel to and away from a screw (or other extending component driven by the motor). Additionally, although some specifically advantageous orientations of motors for particular actuators are discussed below, it should be understood that motor and extension ends of actuators discussed herein can generally be reversed in some examples, (i.e., so that an extension end of the actuator is attached where the motor end of the actuator had been, and vice versa).

With continued reference to FIGS. 5-10, the lift actuator 350 can be coupled between the frame 310 and the lift arm 332. More specifically, as illustrated, the motor end (e.g., a first end) of the lift actuator 350 can be pivotally coupled to the frame 310 at the motor end connection 350A and the extension end (e.g., a second end) of the lift actuator 350 can be pivotally coupled to the lift arm 332 (e.g., to the cross member 336 proximate the lift arm 332) at the extension end connection 350B. Accordingly, extension and retraction of the lift actuator 350 causes the lift arm 332 to move along a travel path (e.g., an arcuate lift path) between a fully-lowered position and a fully-raised position. The lift actuator 350 can be fully retracted to move the lift arm 332 to the fully-lowered position and fully extended to move the lift arm 332 to the fully-raised position.

In some embodiments, and with particular reference to FIG. 10, the lift actuator 350 can be oriented to extend in a rearward direction. That is, the lift actuator 350 can be oriented so that the motor end connection 350A is positioned closer to the front end 310A than is the extension end connection 350B. Correspondingly, in the illustrated example, the motor end connection 350A can also be positioned vertically below the extension end connection 350B.

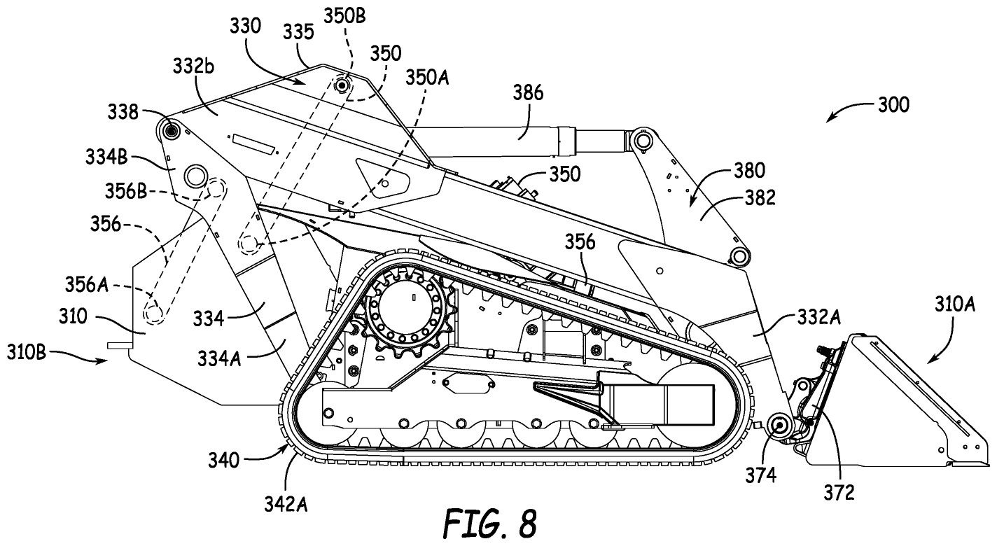

In other embodiments, a lift actuator can extend between a lift arm and other parts of a loader to pivot the lift arm about a lift arm pivot point. For example, as schematically illustrated in FIG. 8, the lift actuator 350 can be coupled to and extend between the lift arm 332 and the connecting link 334. Correspondingly, the lift actuator 350 can be oriented along a forward direction so that the connection to the lift arm 332 (e.g., the extension end connection 350B) is positioned closer to the front end 310A of the loader 300 than is the connection to the connecting link 334 (e.g., at the motor end connection 350A). Additionally, the motor end connection 350A can be positioned vertically below the extension end connection 350B. As a result, the lift arm 332 can be fully lowered when the lift actuator 350 is fully retracted, and can be fully raised when the lift actuator 350 is fully extended. In some embodiments, a motor end connection of a lift actuator can be pivotally coupled to the frame to be coaxial to a connecting link pivot point.

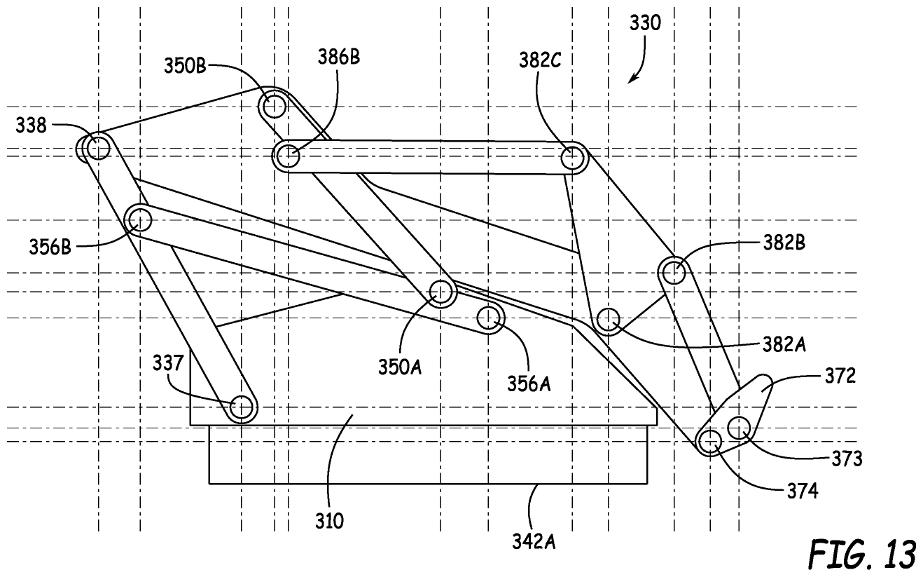

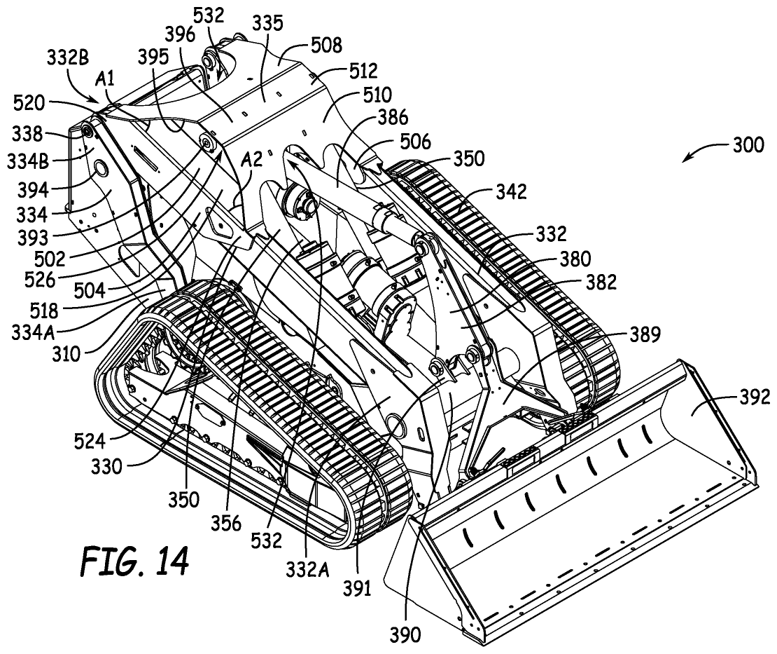

Under examples of the disclosed lift arm structure (e.g., as for the example of FIGS. 10 and 14), some or all of these or other spatial relationships can remain for any position of the lift arm structure 330, including as may provide improved movement and control characteristics for the lift arm structure, or aid in protecting any sensitive electrical components of the lift actuator 350 by keeping the motor end closer to the frame 310. Further, particular relative vertical and horizontal alignment of the various pivot points of the illustrated example (e.g., as collectively shown in FIG. 13) can individually or in different combinations provide generally improved versatility and range of for a lift arm structure.

In some examples, the lift actuator 350 can be in a motor up configuration, in which the screw 352 is positioned generally between the motor 351 and the frame 310 (e.g., so that the motor end connection 350A is between the motor 351 and the frame 310) or is otherwise generally below the motor 351. Orienting a lift actuator in a motor up configuration can allow for more compact packaging. For example, the screw 352 can be positioned generally vertically lower than if the extension actuator 356 were in an opposite, motor down configuration, in which the motor 351 is positioned generally between the screw 352 and the frame 310 (e.g., so that the motor 351 is between the motor end connection 350A and the frame 310). Accordingly, the motor up configuration may reduce the possibility of interference, for example, between the extendable screw 352 and other lift arm structures.

Still referring to FIG. 10 in particular, the loader 300 can include an extension actuator 356 that extends between the frame 310 and the connecting link 334 to move the connecting link 334 (and thereby also the lift arm 332) relative to the frame. In some cases, the extension actuator 356 can be an electrical actuator that is similar to the lift actuator 350. As illustrated, for example, the extension actuator 356 can include a motor end (e.g., a first end) that can be pivotally coupled to the frame 310 at a motor end connection 356A and an extension end (e.g., a second end) that can be pivotally coupled to the connecting link 334 at an extension end connection 356B. As illustrated, the extension end connection 356B is pivotally coupled to the second end 334B of the connecting link 334 to be closer to the lift arm pivot point 338 than to the connecting link pivot point 337. In other embodiments, the extension end connection 356B can be coupled at the lift arm pivot point 338 so that the extension end connection 356B and the lift arm 332 can pivot about a shared pivot axis, or so that the extension end connection 356B is at the first end 334A of the connecting link 334 to be closer to the connecting link pivot point 337 than to the lift arm pivot point 338.

Accordingly, extension and retraction of the extension actuator 356 can cause the connecting link to pivot about the connecting link pivot point 337 (i.e., to pivot in a first, counter-clockwise and second, clockwise direction, respectively, from the perspective of FIG. 10). Correspondingly, moving the extension actuator 356 can move the lift arm pivot point 338 along an arcuate path, relative to the frame 310. Specifically, the connecting link 334 can be moved between a fully-forward position (e.g., a minimum extension position for the extension actuator 356), in which the lift arm pivot point 338 is positioned furthest from the front end 310A of the frame 310, and a fully-rearward position (e.g., a maximum extension position for the extension actuator 356), in which the lift arm pivot point 338 is positioned closest to the front end 310A of the frame 310 (e.g., along a straight line distance between the front end 310A and the lift arm pivot point 374 in the illustrated example). Because the lift arm 332 is coupled to the connecting link 334 at the lift arm pivot point 338, movement of the connecting link 334 also causes the lift arm 332 to move relative to the frame 310.

The arcuate movement of the lift arm pivot point 338 under power of the extension actuator 356 can cause generally front-to-back (e.g., horizontal) movement of the entire lift arm 332, with pivoting movement of the lift arm 332 being also controlled (or constrained) by the lift actuator 350. Consequently, the specific travel path of the lift arm 332 (e.g., a path of the implement carrier pivot point 374) caused by movement of the connecting link 334 can vary depending on a specific extension of the lift actuator 350 between the fully-retracted and fully-extended positions (e.g., as can define a specific elevational position of the lift arm 332 between the lowered and raised positions).

Depending on the particular position and orientation of the extension actuator 356, the connecting link 334 can be fully rearward when the extension actuator 356 is fully extended and can be fully forward when the extension actuator 356 is fully retracted, or vice versa. In the example shown, the extension actuator 356 is positioned in front of the connecting link 334 so that the extension actuator 356 is generally between the connecting link 334 and the front end 310A of the loader 300. Put another way, the pivotal connection between the extension actuator 356 and the frame 310 (e.g., the motor end connection 356A in the illustrated example) is positioned closer to the front end 310A than is the connecting link pivot point 337. Correspondingly, the extension actuator 356 can be oriented along a rearward direction so that the motor end connection 356A (or, generally, the connection to the frame 310) is positioned closer to the front end 310A of the loader 300 than is the extension end connection 356B (or, generally, the connection to the connecting link 334). As a result, the connecting link 334 can be fully rearward when the extension actuator 356 is fully extended, and can be fully forward when the extension actuator 356 is fully retracted. Additionally for the illustrated example, the motor end connection 356A can be positioned vertically below (although not vertically aligned with) the extension end connection 356B. Under examples of the disclosed lift arm structure (e.g., as for the example of FIG. 10), some or all these spatial relationships can remain for any position of the lift arm structure 330, including as may provide improved movement and control characteristics for the lift arm structure or aid in protecting any sensitive electrical components of the extension actuator 356.

In other embodiments, for example, as schematically illustrated with dashed lines in FIG. 8, it is possible that the extension actuator 356 is positioned rearward of the connecting link 334 so that the connecting link 334 is generally between the extension actuator 356 and the front end 310A of the loader 300. Put another way, the connecting link pivot point 337 can be positioned closer to the front end 310A than is a pivotal connection between the extension actuator 356 and the frame 310. Correspondingly, the extension actuator 356 can be oriented along a forward direction so that the connection to the connecting link 334 (e.g., the extension end connection 356B) is positioned closer to the front end 310A of the loader 300 than is the connection to the frame 310 (e.g., at the motor end connection 356A). Additionally, the motor end connection 356A can be positioned vertically below the extension end connection 356B. Under examples of the disclosed lift arm structure (e.g., as for the example of FIG. 10), some or all of these spatial relationships can remain for any position of the lift arm structure 330, including as may provide improved movement and control characteristics for the lift arm structure or aid in protecting any sensitive electrical components of the extension actuator 356. As a result, the connecting link 334 can be fully rearward when the extension actuator 356 is fully retracted, and can be fully forward when the extension actuator 356 is fully extended.

Generally, the spatial arrangements discussed above—alone and in various combinations—can allow for a more compact height of the lift arm structure 330 as well as improved visibility overall (e.g., particularly for operators behind the power machine 300). As shown in FIG. 10, for example, the side-by-side arrangement of the various actuators 350, 356, 386 and nesting of the actuators into the frame 310 can result in a relatively compact height of the power machine 300 when the lift arm structure 330 is in the fully retracted configuration. This effect can also be enhanced by the relatively low mounting of the lift and extension actuators 350, 356 on the frame 310. Indeed, some configurations may even further reduce total height with differently oriented tilt or other actuators. For example, the lift actuator 350 can in some cases be pivotally connected to a point that is lower on the lift arm 332 (e.g., at or below the top of the frame 310) or the tilt actuator 386 can be directly (or otherwise) connected to the implement carrier 374 rather than connected via a rocker link. In this regard, as also noted above, some configurations of the disclosed lift arm and frame structures may be particularly beneficial for mini-loaders (e.g., with walk-behind or rearward stand-on operator stations) due to the corresponding improved visibility from the rear of the power machine.

Regardless of the position of the extension actuator 356 relative to the connecting link 334, the extension actuator 356 can be oriented in either of a motor up or motor down configuration. For example, as illustrated in FIG. 10, the extension actuator 356 is in a motor up configuration, similar to the lift actuators 350. Orienting the extension actuator 356 in this way can allow for more compact packaging. For example, a screw 357 of the extension actuator 356 can be positioned generally vertically lower than if the extension actuator 356 were in the motor-up configuration, which may reduce the possibility of interference with other lift arm structures.

Of note, in some cases, multiple actuators can be provided for particular functions (e.g., two of the lift actuators 350 as shown) and single actuators can be provided for other functions (e.g., single extension and tilt actuators 356, 386 as shown). In some cases, use of single actuators for certain functions (or other similar arrangements) can allow certain actuators to be located between others, as can improve spatial efficiency, protection of certain actuators or components, or other aspects of

By pivotally supporting a lift arm on a connecting link that is pivotally coupled to a frame of a loader, a lift arm structure can be articulated (e.g., via extension and retraction of lift and extension actuators) to move along a variety of travel paths to any position within in lift envelope. For example, as compared with conventional lift arm structures that move primarily along one or more fixed, substantially vertical lift paths, lift arm arrangements, as described above, can move in any direction within the bounds of a lift envelope. Accordingly, the lift arm structure can be articulated to move between any two points in the lift envelope, including, along substantially vertical, substantially horizontal, or otherwise curvilinear travel paths.

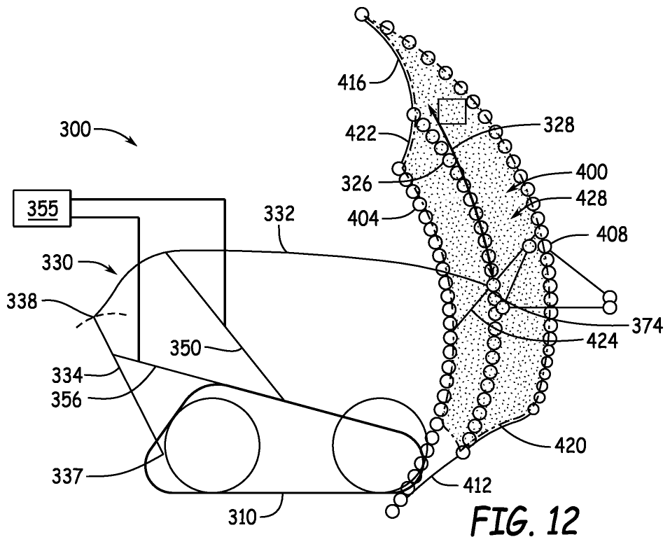

For example, with reference to FIG. 12, the lift arm structure 330 is operable to move the lift arm 332 (e.g., the first end 332A), and more specifically, the implement carrier pivot point 374 to any position within a lift envelope 400 of the loader 300. Due to the particular configuration of the lift arm structure 330 (e.g., the relative connections between the lift arm 332 and the connecting link 334) the lift envelope 400 has a substantially curved four-sided shape defined by a forward bound 404, a rearward bound 408, a lower bound 412, and an upper bound 416. In other embodiments, a lift envelope can be shaped differently. In the illustrated example, the lift envelope thus roughly exhibits a curved trapezoid shape with, from a perspective at the center of gravity of the power machine 300, similarly concave profiles for the forward and rearward bounds 404, 408 and oppositely concave profiles for the upper and lower bounds 412, 416. In other examples, other general shape profiles are possible.

The rearward bound 404 can be defined by a first path of the implement carrier pivot point 374 as the lift arm 332 moves between the lowered position and the raised position (e.g., by fully extending and retracting the lift actuator 350 with the connecting link 334 in a fully-rearward or other minimum-extension position). The forward bound 404 can be defined by a second path of the implement carrier pivot point 374 as the lift arm 332 moves between the lowered position and the raised position (e.g., by fully extending and retracting the lift actuator 350 with the connecting link 334 moved away from a minimum-extension position, for example, to be in the fully-forward or other maximum-extension position). Accordingly, the rearward bound 404 and the forward bound 408 can be arcuate paths that are oriented to move the implement carrier pivot point 374 in a substantially vertical direction. For a given extension of the connecting link 334 (e.g., a given extension of the extension actuator 356), actuation of the lift actuator 350 causes the implement carrier pivot point 374 to move along a travel path between the lower bound 412 and the upper bound 416. The specific shape of the travel path induced by extension of the lift actuator 350 may vary depending on the particular extension of the extension actuator 356 (e.g., a position of the connecting link 334).

The lower bound 412 can be defined by a third path of the implement carrier pivot point 374 as the lift arm 332 moves with the connecting link 334 when the connecting link 334 moves between the fully-forward and fully-rearward positions (e.g., by fully retracting and fully extending the extension actuator 356, respectively, with the lift arm 332 in a lowered position). The upper bound 416 can be defined by a fourth path of the implement carrier pivot point 374 as the lift arm 332 moves with the connecting link 334 when the connecting link 334 moves between the fully-forward and fully-rearward positions (e.g., by fully retracting and fully extending the extension actuator 356, respectively, with the lift arm 332 in a raised position). Accordingly, for a given elevation of the lift arm 332 (e.g., a given extension of the lift actuator 350), actuation of the extension actuator 356 causes the implement carrier pivot point 374 to move along a travel path between the rearward bound 404 and the forward bound 408.

The specific shape of the travel path induced by extension of the extension actuator 356 may vary depending on the particular extension of the lift actuator 350, but may generally induce vertical or horizontal movement, alone or in combination through selective application of actuator control. In general, a wide range of movements can thus be accomplished via cooperative control of a lift actuator to rotate a lift arm in an arc about the lift arm pivot, and an extension actuator to pivot the lift arm about an instance center defined by an intersection of an connecting link line of action and the extension actuator line of action. Thus, for example, a travel path 420 along the lower bound 412 can be an arcuate travel path that is downwardly concave, and which causes a combination of vertical and horizontal movement of the implement carrier pivot point 374. Additionally, a travel path 422 along the upper bound 416 can be an arcuate path that moves the implement carrier pivot point 374 in a substantially vertical direction, but which also moves the implement carrier pivot point 374 forward along a first portion of the travel path 422 and rearward along a second portion of the travel path 422. Further, a travel path 424 between the lower bound 412 and the upper bound 416, can induce substantially linear movement on a diagonal direction (e.g., at approximately a 45 degree angle relative to a horizontal plane).

Thus, in the illustrated example, the lift arm structure 330 is at a fully-lowered and fully-retracted position (i.e., a minimum lift position) when the implement carrier pivot point 374 is positioned at the intersection of the rearward bound 404 and the lower bound 412, and at a fully-raised and fully-extended position (i.e., a maximum lift position) when the implement carrier pivot point 374 is positioned at the intersection of the forward bound 408 and the upper bound 416. Correspondingly, the lift arm 332 can be at a fully-lowered position, but not necessarily a fully-rearward or fully-forward position, when the implement carrier pivot point 374 is positioned along the lower bound 412, and at a fully-raised position, but not necessarily a fully-rearward or fully-forward position, when the implement carrier pivot point 374 is positioned along the upper bound 416. Similarly, the lift arm 332 can be at a fully-rearward position, but not necessarily a fully-raised or fully-lowered position, when the implement carrier pivot point 374 is positioned along the rearward bound 404, and at a fully-forward position, but not necessarily a fully-raised or fully-lowered position, when the implement carrier pivot point 374 is positioned along the forward bound 408.

In other implementations, a lift arm can be controlled to remain within other envelopes, including with the same or different particular structural arrangements as are shown in FIGS. 5 through 10. Further, operational movement of a relevant pivot point (e.g., the implement carrier pivot point 374) can be restricted to an operational envelope within a structurally-defined lift envelope, including as described in greater detail below.

In some embodiments, a loader can include a controller (e.g., an electronic controller) that can be configured to selectively operate actuators to articulate a lift arm structure in accordance with an operator input (e.g., a remote operator input at an operator control input, or an autonomous controller or other electronic control system. For example, the loader 300 can include a controller 355 that can be configured to selectively control the extension and retraction of each of the lift actuator 350 and the extension actuator 356 to move the lift arm structure 330 along a corresponding travel path to move between any two points of the lift envelope 400 (or the operational envelope 428, etc.), and thereby along effectively any shape of travel path within the relevant envelope. For example, the controller 355 can be configured to command the implement carrier pivot point 374 to a desired position, or to command a ratio of an extension length of the lift actuator 350 to an extension length of the extension actuator 356.

In some cases, a controller can be configured to operate in different operational modes, which may allow an operator to more easily command a desired movement. For example, in some embodiments, the controller 355 can be configured to operate in a lockout mode, wherein only one of the lift actuator 350 or the extension actuator 356 is operated at any one time. Accordingly, an operator can command the lift arm structure 330 to move the implement carrier pivot point 374 along a lift path (e.g., by controlling the lift actuator 350 with the extension actuator 356 locked at a given extension) or along an extension path (e.g., by controlling the extension actuator 356 with the lift actuator 350 locked at a given extension). As another example, the controller 355 can be configured to operate in a combined operation mode, in which the controller 355 is configured to map an operator input (e.g., an operator input at a two-axis joystick) to a commanded directional movement of the implement carrier pivot point 374 along a travel path between two points (e.g., between a lowest point and a highest point, along an inflected travel path, along a linear travel path, etc.). Accordingly, the controller 355 can selectively control each of the lift actuator 350 and the extension actuator 356 to move the implement carrier pivot point 374 along the path as directionally commanded by the operator input.

As still another example, in some cases, the controller 355 can be configured to operate in a Cartesian mode, in which the controller 355 can selectively operate the lift actuator 350 and the extension actuator 356 to move the implement carrier pivot point 374 along only a vertical (or substantially vertical) travel path or only a horizontal (or substantially horizontal) travel path, even for operator inputs that would otherwise command a deviation from substantially vertical or substantially horizontal. Thus, for example, an operator can cause a relevant pivot point on a lift arm to trace essentially rectangular paths without necessarily providing a precisely rectangular-path input.

As still another example, in some cases, the controller 355 can be configured to operate in a radial lift mode. For example, in the arrangement illustrated in FIG. 12, holding the extension actuator 356 at a particular extension will result in the connecting link 334 being held at a particular angle relative to vertical. In other words, a fixed length of the extension actuator 356 can orient the lift arm pivot point 338 at a particular fixed location relative to the frame 310. Accordingly, with the extension actuator 356 at a fixed length, operation of the lift actuator 350 can cause the lift arm 332 to move along a radial lift path, centered at the pivot point 338. Moreover, in contrast to conventional radial-path machines, the extension actuator 356 can be controlled (e.g., based on operator input or otherwise) to adjust the position of the pivot point 338. Thus, the lift arm structure 330 can be moved to selectively change the particular radial path followed by the lift arm 332 during actuation of the lift actuator 350. In this regard, the relatively low location of the pivot 337 for the connecting link 334 can also beneficially result in a relatively low amount of extension or retraction of the extension actuator 356 causing a relatively large change in position for the pivot 338.

In some cases, the power machine 300 can be selectively operated in a non-radial lift mode (e.g., rather than in a radial lift mode) so that the lift arm 332 follows a vertical or other non-radial lift path. For example, to trace a desired non-radial lift path, the extension actuator 356 can be controlled to extend or retract concurrently with actuation of the lift actuator 350. As a result of the synchronized movement of the actuators 350, 356, various multi-pivot movements can be implemented for the lift arm 332. In particular, with concurrent (or other) movements of the actuators 350, 356 determined based on a target path and known geometric relationships between the various links and pivot points (as further detailed above), the lift arm 332 can be configured to be moved along a plurality of non-radial paths, including—selectively—any of a plurality of conventional vertical lift paths.

In some implementations, concurrent control of the extension and lift actuators 356, 350 can also cause the lift arm 332 to trace lift paths that may not be possible with conventional radial or vertical path lift arm structures. For example, various combinations of extension/retraction of the lift actuator 350 and the extension actuator 350 (e.g., determined based on the structural lengths and current orientation of the lift arm structure 330) can be used to extend the implement carrier pivot point 374 (or another lift arm structure) horizontally or substantially horizontally at any variety of heights included in the lift envelope 400. For example, for a range of positions of the connecting link 334, the extension actuator 356 can be retracted (or extended) concurrently with extension (or retraction) of the lift actuator 350 to trace a substantially horizontal path with an implement. In some cases, users can correspondingly select a telehandler mode (e.g., as opposed to a radial lift mode or a non-radial lift mode) to allow substantially vertical movement at a variety of lift heights, or can otherwise implement telehandler operations at a variety of lift heights (e.g., in a Cartesian mode, as also discussed above).

As with other operational modes, entry into a radial or non-radial (or other) lift mode can sometimes be based on receiving an operator input (e.g., from a toggle switch or button). In some cases, in response to an operator input (or as a default), the controller 355 can selectively operate in a non-radial lift mode (e.g., the Cartesian mode or others noted above). In some cases, in response to a different operator input (or as a default), the controller 355 can selectively operate in a radial lift mode. Thus for example, the controller 355 can receive an operator input for a target movement of the lift arm 332 that may correspond to a non-radial lift path 326, and can responsively command movement of the actuators 350, 356 to actually move the lift arm 332 with a radial lift path 328.

Generally, as also discussed above, a controller can be preprogrammed to selectively control one or more actuators according to a commanded movement and a known geometry of the relevant lift arm structure, including during operation in one or more of the modes discussed above. In some cases, control of a lift arm as disclosed herein can also depend on other operational inputs (e.g., spatial location information for parts of a lift arm, as provided by inertial or other sensors).

In some cases, a controller can be configured to limit the movement of a lift arm structure to an operational envelope that is different from a structurally defined lift envelope (e.g., a sub-region of a lift envelope defined by the structural parameters of the links and pivots of the relevant lift arm structure). Control based on an operational envelope can, for example, prevent the lift arm structure, or an implement supported thereon, from contacting other parts of the loader (e.g., a frame or traction system) or from interfering with other spaces or particular operations. For example, still referring to FIG. 12, the controller 355 can be configured to restrict movement of the lift arm structure 330 so that the implement carrier pivot point 374 remains within an operational envelope 428 (shaded region in FIG. 12). In the illustrated example, the operational envelope 428 prevents the implement carrier pivot point 374 from reaching the intersection of the rearward bound 404 and lower bound 412. Accordingly, an operationally fully-lowered position of the lift arm structure 330 can be at a vertically lowest point within the operational envelope 428, although operational envelopes can define other spatial limits for controlled movement of a lift arm in other examples.

Consequently, the operational envelope 438 can effectively change the operational bounds of a lift envelope, including to further limit movement of a lift arm beyond structural constraints (e.g., lift envelope bounds defined by pivot placement and adjustable or fixed link lengths). For example, in accordance with the operational envelope 428, an upper portion of a rearward (or retracted) bound can be defined with the extension actuator 356 at a minimum arm-extension position, i.e., a position (e.g., length) of the extension actuator 356 at which the lift arm is extended by a minimum operational distance (e.g., corresponding to a fully-rearward position of the connecting link 334, and a maximum (or minimum) operational extension of the extension actuator 356). In contrast, a lower portion of the rearward bound can be defined with the extension actuator 356 moved away from the minimum arm-extension position, i.e., in a position (e.g., length) at which the lift arm is extended by more than the minimum operational distance (e.g., with the connecting link 334 pivoted forward from the fully-rearward position, and a minimum (or maximum) operational extension of the extension actuator 356). In such an example, by moving the extension actuator 356 away from the minimum arm-extension position (e.g., to trim the rearward bound 404), the implement carrier 372 can be prevented from contacting the frame 310.

In contrast, in some cases, a forward (or extended) bound can be defined with the extension actuator 356 moved to a maximum arm-extension position, i.e., a position of the extension actuator 356 at which the lift arm is extended by a maximum operational distance (e.g., corresponding to a fully-forward position of the connecting link 334, and a minimum (or maximum) operational extension of the extension actuator 356).

Continuing, in some embodiments, lift actuators and extension actuators can be advantageously arranged relative to one another, as well as relative to other components or structures of a loader. For example, as is best shown in FIG. 7, the lift actuator 350 can be positioned along a lateral side of the loader 300 to be inboard of the lift arm 332. Positioning the lift actuator 350 to be inboard of the lift arm 332 can allow for the lift arm 332 to be moved lower than if the lift actuator 350 where aligned (e.g., to be vertically below) with the lift arm 332. In addition, the extension actuator 356 can be positioned inboard of both the lift arm 332 and the lift actuator 350. In some cases, the extension actuator 356 can be aligned along a longitudinal plane 360 (e.g., a vertical plane extending in a front-to-back direction and positioned centrally between the lateral sides) of the loader 300.

Additionally, referring now to FIG. 10, a lift actuator and an extension actuator can be arranged so that the actuators (e.g., the screws of the actuators) do not cross for any position of a lift arm structure, including as can provide various benefits for packaging, assembly, serviceability, etc. In that regard, the lift actuator 350 can define a first line 358 extending from the motor end connection 350A to the extension end connection 350B (e.g., a line that can be coincident with the extension axis 354). Similarly, the extension actuator 356 can define a second line 359 extending from the motor end connection 356A to the extension end connection 356B. For the illustrated example, for any position of the lift arm structure 330 (e.g., for any extension of the lift actuator and the extension actuator 356), the first line 358 and the second line 359 will not cross one another as projected onto the longitudinal plane 360. However, in other embodiments, it is possible to have lift and extension actuators that do cross in at least one position of a lift arm structure.

Lift actuators and extension actuators can be arranged in various ways so that they do not cross. As one particular example, still referring to FIG. 10, with the lift arm structure 330 in the fully-lowered position, the motor end connection 356A of the extension actuator 356 can be positioned vertically below and in front of the motor end connection 350A of the lift actuator 350. In other embodiments, motor ends can be arranged differently, for example so that the motor end connection 356A of the extension actuator 356 and the motor end connection 350A of the lift actuator 350 are aligned to rotate about a shared pivot axis (not shown). Further, the extension end connection 356B of the extension actuator 356 can be positioned vertically below and rearward of the extension end connection 350B of the lift actuator 350. Accordingly, the lift actuator 350 can be generally above the extension actuator 356 so that the extension end connection 356B is between the extension end connection 356B and the frame 310, and so that the motor end connection 356A is between the motor end connection 350A and the frame 310. In some embodiments, these relationships can remain for all positions of the lift arm structure 330.

Other relative alignments of pivotal connections between different lift arm members of a lift arm structure (e.g., rigid or extendable links) can also provide improved functionality as compared to conventional designs. For example, particular horizontal and vertical alignment (or non-alignment) of particular pivot points can provide through improved smoothness and range of motion for an implement secured to a lift arm. In this regard, FIG. 13 illustrates the vertical and horizontal alignment of each pivot point for the lift arm structure 330 at a fully-lowered, fully-rearward, and fully rolled back position. (Those of skill in the art will also recognize therein, in combination with known principles of geometry and the illustrated lift and operational envelopes 400, 428 (see FIG. 12)), an inherent disclosure of the relative vertical and horizontal alignment of these points at all other structurally possible and operationally permitted positions.) In particular, the illustrated individually and collective alignments of the movable pivot points at 338, 356B, 350, 374 relative to the fixed pivots at 337, 350A, 356A, individually and collectively, can provide improved performance and stability relative to conventional designs-including at particular positions (e.g., at vertices or bounds of a lift or an operational envelope) or over particular ranges of movement (e.g., over an entire relevant envelope). However, other illustrated alignments can also be notably advantageous in some examples.

In some embodiments, components of a lift arm structure can be arranged relative to a traction system of a loader. For example, as mentioned above the loader 300 includes a traction system with tractive elements configured as endless tracks 342. More specifically, a first, left track assembly 342A and a second, right track assembly 342B are operatively supported on opposing left and right lateral sides of the frame 310, respectively, and extend in a front-to-back direction between a front end 310A and a rear end 310B of the frame 310. Like with the lift actuator 350, while the discussion below only refers to the track assembly 342A, it is equally applicable to the second track assembly 342B.

As is shown in FIG. 10, for example, the track assembly 342A includes a track frame 343 (see FIG. 6) that supports and is surrounded by an endless track 344, which rotates under power to propel the loader 300 over a support surface. To rotatably support and power the endless track 344 on the track frame 343, the track assembly 342A includes a drive sprocket 345 that is rotatably coupled to the track frame 343 to rotate about a drive sprocket axis 345A. More specifically, the drive sprocket 345 is fixedly coupled to a drive axle (not shown) of the loader 300 that is powered by the power source 320 (e.g., the battery 322), so that the drive sprocket 345 rotates with the drive axle. Additionally, to help keep the endless track 344 aligned as it rotates on the track frame 343, the track assembly 342A includes a first idler 346 (e.g., a front idler) rotatably coupled at a first end 343A (e.g., a front end) of the track frame 343 to rotate about a first idler axis 346A (e.g., at a frontmost axle), and a second idler 347 (e.g., a rear idler) rotatably coupled at a second end 343B (e.g., a rear end) of the track frame 343 to rotate about a second idler axis 347B (e.g., a rearmost axle). The drive sprocket 345 can be positioned so that the drive sprocket axis 345A is between the first idler axis 346A and the second idler axis 347A in a front-to-back direction.

Still referring to FIG. 10, for all positions of the lift arm structure 330, the motor end connection 350A of the lift actuator 350 and the motor end connection 356A of the extension actuator 356 can be positioned forward of the second idler axis 347B (e.g., a rearmost axle), or forward of the drive sprocket axis 345A. Additionally, the motor end connection 350A of the lift actuator 350 and the motor end connection 356A of the extension actuator 356 can be positioned rearward of the first idler axis 346A (e.g., a frontmost axle). Accordingly, motor end connection 350A of the lift actuator 350 and the motor end connection 356A of the extension actuator 356 (e.g., where applicable, a shared pivot axis of the lift actuator 350 and the extension actuator 356) can be between the drive sprocket axis 345A and the first idler axis 346A in a front-to-back direction. Further, in some embodiments, the connecting link 334 can be rearward of the second idler axis 347B.

In some embodiments, a loader can include a tilt system that is configured to adjust an attitude of an implement (e.g., an implement carrier) relative to a lift arm, on which the implement is supported. For example, the loader 300 includes a tilt system 380 that is configured to adjust the attitude of the implement carrier 372 relative to the lift arm 332 (e.g., by pivoting the implement carrier 372 about the implement carrier pivot point 374).

The tilt system 380 can generally include a rocker link 382, a tilt link 384, and a tilt actuator 386 (e.g., an electric actuator similar to the lift actuator 350 and the extension actuator 356), which can be arranged relative to one another to form a bell crank that pivots the implement carrier 372 when the tilt actuator 386 extends and retracts. More specifically, the rocker link 382 defines a first pivot point 382A, a second pivot point 382B, and a third pivot point 382C. The rocker link 382 can be pivotally coupled to the lift arm 332 at the first pivot point 382A. Correspondingly, the tilt link 384 and the tilt actuator 386 can be coupled between the lift arm 332 and the implement carrier 372 to pivot the rocker link 382 and the implement carrier 372 relative to the lift arm 332.

As best shown in FIG. 10, the tilt link 384 can extend between the rocker link 382 and the implement carrier 372, with a first end 384A pivotally coupled to the rocker link 382 at the second pivot point 382B and a second end 384B pivotally coupled to the implement carrier 372 at an attachment point 373. Correspondingly, the tilt actuator 386 can extend between the rocker link 382 and the lift arm 332, with a motor end connection 386A (e.g., a first end) pivotally coupled to the lift arm 332 and an extension end connection 386B (e.g., a second end) pivotally coupled to the rocker link 382 at the third pivot point 382C. In some cases, the motor end connection 386A of the tilt actuator 386 and the extension end connection 350B of the lift actuator 350 can be coupled to the lift arm 332 to rotate about a shared pivot axis. Also, by positioning the tilt actuator 386 substantially rearward of the rest of the tilt system 380 (e.g., the rocker link 382 and the tilt link 384) the tilt actuator 386 can be moved away from the implement carrier 372, and any implement supported thereon, to help protect the tilt actuator 386 from damage. Similarly, the tilt actuator 386 can be oriented in a motor down configuration, with a motor 387 positioned below the motor end connection 386A (e.g., between the motor end connection 386A and the frame 310), as may further protect sensitive motor components from damage.

The attitude of the implement carrier 372 can be adjusted by extending and retracting the tilt actuator 386 to pivot the rocker link 382 about the first pivot point 382A. Pivoting of the rocker link 382 simultaneously induces movement of the tilt link 384, which causes the implement carrier 372 to rotate about the implement carrier pivot point 374. The tilt actuator 386 can be configured to move between a fully-retracted position and a fully-extended position. The fully-retracted position can correspond with a rolled back position of the implement carrier 372, in which the implement carrier 372 is rotated up and toward the lift arm 332 about the implement carrier pivot point 374 (e.g., in an anti-clockwise direction as shown in FIG. 10). The tilt actuator 386 can be rearward of the first pivot point 382A when the implement carrier 372 is rolled back with the lift arm 332 fully-lowered, as well as for other positions of the lift arm 332. The fully-extended position can correspond with a rolled out position of the implement carrier 372, in which the implement carrier 372 is rotated out, i.e., down and away from the lift arm 332 about the implement carrier pivot point 374 (e.g., in a clockwise direction as shown in FIG. 10). In some cases, the extension end connection 386B of the tilt actuator 386 can be forward of the first pivot point 382A in the rolled out position.

In other embodiments, the tilt system 380 can be configured differently. For example, in some embodiments, a tilt actuator can have a motor end pivotally coupled to a rocker link and an extension end pivotally coupled to a lift arm. In other embodiments, the positions of a tilt link and tilt actuator can be reversed so that the tilt link can be coupled between a rocker link and a lift arm, and the tilt actuator can be coupled between the rocker link and an implement carrier. Further, other tilt systems entirely (or no tilt systems) can be used in some cases, including systems with simply a tilt actuator pivotally and directly coupled to a lift arm and to an implement carrier (or other implement-pivoting structure).

Continuing, a tilt system can be disposed generally above a lift arm (e.g., so that the lift arm is between the tilt system and the frame of the loader) when a corresponding lift arm structure is in a fully-lowered position. For example, as illustrated in FIG. 10, the tilt system 380 is disposed generally above the lift arm 332. That is, other than at the connections to the lift arm 332 (e.g., the motor end connection 386A of the tilt actuator 386 and the first pivot point 382A of the rocker link 382), the tilt system 380 is arranged so that the lift arm 332 is between the tilt system 380 and the frame 310 of the loader 300. Consequently, the tilt actuator 386 can also be disposed substantially above the lift actuator 350 or the extension actuator 356 (e.g., so that the tilt actuator 386 is above a majority of a length of the lift actuator 350 or the extension actuator 356, taken between the respective motor and extension ends). That being said, it is also possible that some portions of the lift actuator 350 or the extension actuator 356 can be above the tilt actuator 386. For example, the tilt actuator 386 can be positioned so that the extension end connection 350B of the lift actuator 350 is above the motor end connection 386A of the tilt actuator 386 when the lift arm 332 is fully lowered.

Additionally, in some embodiments, a tilt actuator can be oriented so that an extension actuator of the tilt actuator does not intersect an implement carrier. For example, as shown in FIG. 10, the tilt actuator 386 can be oriented so that an extension axis 388 of the tilt actuator 386 is horizontal when the lift arm 332 is fully lowered and the implement carrier 372 is rolled back. As a result, even as the tilt actuator 386 pivots relative to the lift arm during extension and retraction, the extension axis 388 may not intersect with the implement carrier 372 (although it may intersect with an implement supported by the carrier).

Relatedly, in some embodiments, the tilt actuator 386 can be aligned along the longitudinal plane 360 of the loader 300. As a result, and as best seen in FIG. 7, the tilt actuator 386 can be vertically above the extension actuator 356 and inboard of the lift actuator 350. By arranging the various actuators in this way, the actuators can nest with one another in a fully-lowered position of the lift arm structure. Specifically, the extension and tilt actuators 356, 386 can be vertically stacked relative to one another, as well as being inboard of the lift actuators 350. Accordingly, by nesting the actuators with one another in this way, a clearance height of the power machine 300, with the lift arm 332 in a fully-lowered position, can be maintained or reduced, while also allowing for an increased a maximum lift height in a fully-raised position, as compared with conventional lift arm arrangements. Relatedly, because the actuators, and more specifically the lift and extension actuators 350, 356 are positioned inboard and generally below of the rest of the lift arm structure 332 (e.g., the lift arm 332 and connecting link 334), as well as being at least partially recessed into the frame 310, they can be better protected from damage. Similarly, because tilt actuator 386 is positioned rearward of the rocker link 382, the tilt actuator 386 can be disposed further away from any implement that is supported on the lift arm 332, which can reduce the risk of damage to the tilt actuator 386.

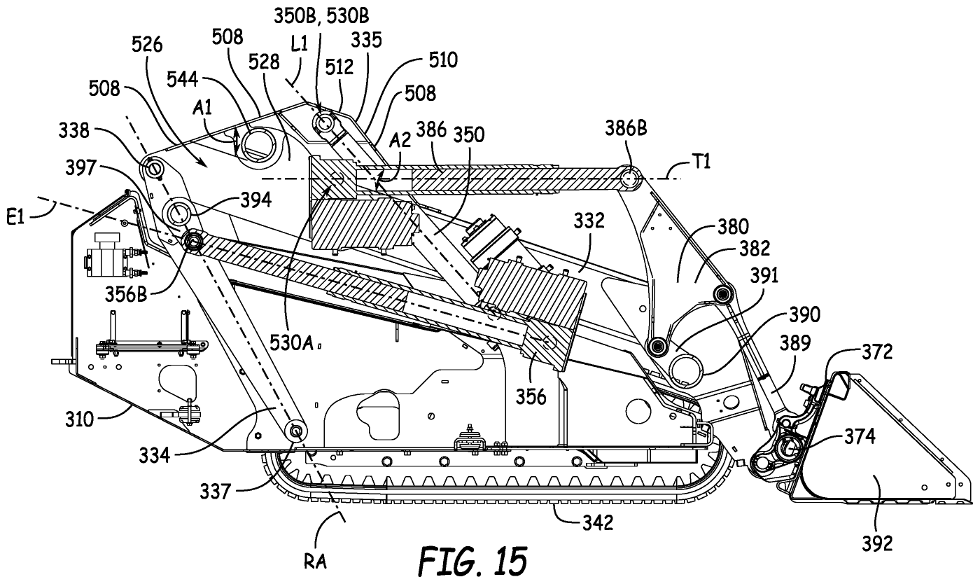

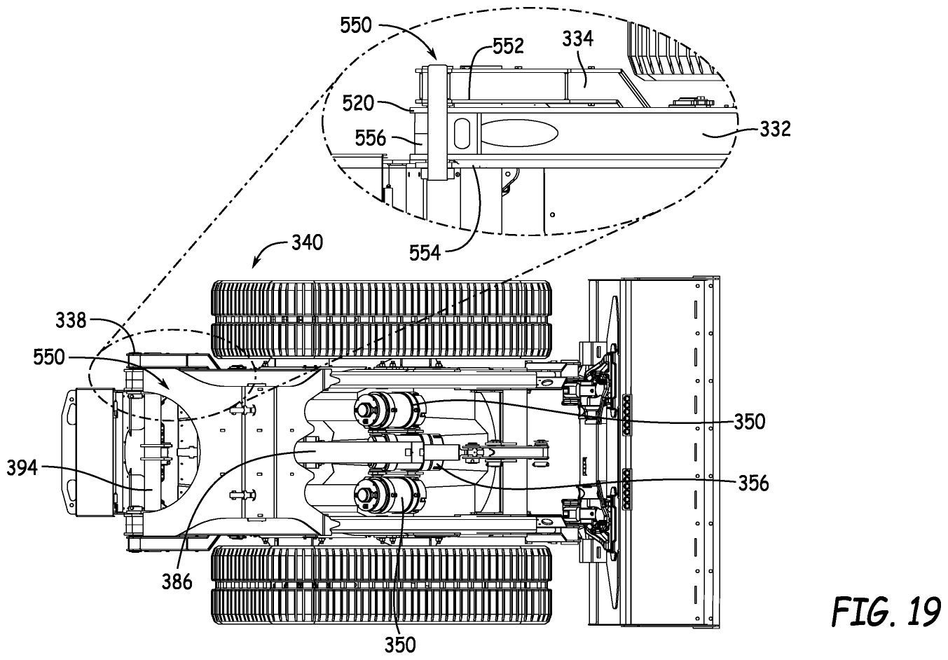

FIGS. 14-22 illustrate another configuration of the tracked loader 300 illustrated in FIGS. 5-10, with like reference numerals generally referring to like features, unless otherwise indicated. In particular, the lift arm structure 330 of the loader 300 as configured in FIGS. 14-22 can include a bridge structure 335 that forms a rigid structural extension from and between (and above) the lift arms 332. As further discussed below, the bridge structure 335 can include a plurality of internal reinforcement structures (not shown in FIG. 14) that can provide improved mounting configurations for various actuators of the loader 300, as well as generally increase structural stability of and protection for various components of the loader 300. As shown in FIGS. 14 and 19 in particular, the loader 300 as configured in FIGS. 14-22 can also include a Y-shape link 389 disposed between the rocker link 382 and the implement carrier 372 (see FIG. 15), which can be used for the loader 300 as one example connector between the tilt actuator 386 and a bucket 392 or other implement (e.g., via attachment to an intervening implement carrier 372, as shown).

As shown in FIG. 15 in particular, the lift arm structure 330 may include a plurality of cross members extending between the two lift arms 332 and other components of the lift arm structure 330. Such cross members can generally be formed as torsion tubes or other beam structures, and can provide improved structural stability for the lift arms 332 and for the lift arm structure 330 overall.

As a particular example, a torsion cylinder 390 (or other torsion tube) may be disposed between the lift arms 332 toward a first end 332A of the lift arms 332 (see FIG. 15). In some embodiments, the torsion cylinder 390 may include a connecting structure that connects with and operatively supports the tilt system 380. In some embodiments, such a connecting structure can be centrally located on a cross member, can project (e.g., as a cam) away from a centerline or outer profile of the cross member. For example, a connecting structure 391 as shown in FIGS. 14, 15, and 17 is located centrally on and extends in a cam arrangement away from the torsion cylinder 390. Such a connecting structure can take a variety of forms, including but not limited to a clevis bracket mount with parallel cammed plates (as shown).

The rocker link 382 of the tilt system 380 pivotally engaged with the connecting structure 391 in the illustrated example, and is also connected to tilt actuator 386 and to the Y-shaped link 389 in a bell crank arrangement. The Y-shaped link 389 is connected to the implement carrier 372 (see FIG. 15) that secures the bucket 392, and actuation of the tilt actuator 386 can thus pivot the implement carrier 372 relative to the lift arms 332 via a bell crank movement of the rocker link 382. In particular, the laterally spaced coupling locations between the Y shape link 389 and the tilt system 380 can provide a more even distribution of load between the rocker link 382 and the lift arms 332 (e.g., while lifting the bucket 392) as well as generally improved structural stability for the lift arm structure 330. Further, the centrally supported connection with the torsion cylinder, and the centrally supported cammed clevis mount in particular, can provide improved loading characteristics for components of the lift arms 332 during tilt operations and can also generally help to facilitate the illustrated improved mounting of the tilt actuator 386 (as further discussed above and below).

As another example, a torsion tube 394 (e.g., torsion cylinder, as shown) extends between opposing arms of the connecting link 334. In the illustrated example, the torsion tube 394 is located toward the second end 334B of the connecting link 334, between the lift arm pivot point 338 and the pivoting joint at the extension end connection 356B (i.e., the joint between the extension actuator 356 and the connecting link 334). As show in FIG. 15, the torsion tube 394 is located along a line of action RA of the connecting link 334, between the lift arm pivot point 338 and the end connection 356B, as well as between the lift arm pivot point 338 and the connecting link pivot point 337.

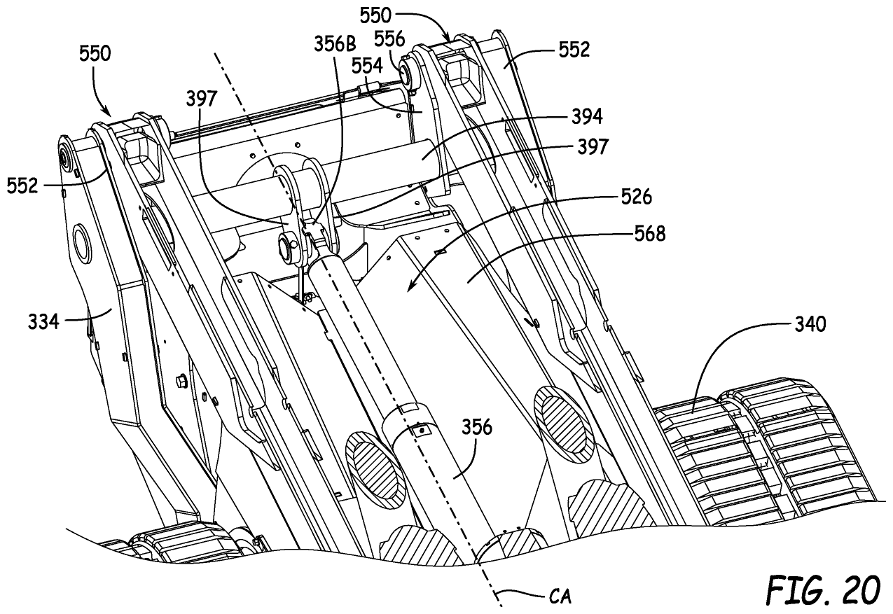

To provide improved structural characteristics for the lift arm structure 330 overall, the torsion tube 394 is also aligned to be secured to the extension actuator 356. In particular, similar to the torsion tube 390 and the rocker link 382, the torsion tube 394 supports a connecting structure 397 formed as a centrally located, cammed, clevis-mount structure extending from connecting link 334 (see also FIG. 20). As with the connecting structure 391, the connecting structure 397 can alternatively include mounting structures other than parallel cammed plates (as shown).

As also noted above, the lift arm pivot point 338, the torsion tube 394, the connecting structure 397, and the connecting link pivot point 337 can be beneficially aligned along the line of action RA. The extension actuator 356 may then extend and retract transverse to the line RA, along the extension axis E1 (see also line 359 in FIG. 10), to pivot the connection link 334 about the connecting link pivot point 337. In some embodiments the extension axis E1 may be parallel with a top surface of the lift arms 332 in a fully lowered position (see FIG. 15).

Other cross members can also be provided in some cases. For example, as further discussed below, a torsion tube 544 (e.g., a cylinder as shown) can extend laterally across the bridge structure 335 to enhance the structural strength of the bridge structure 335 overall, as well as relative to pivoting joints between the lift arm 332 and various actuators at the bridge structure 335 (as also discussed below). In some cases, the torsion cylinder, and the bridge structure 335 in general, can thus provide improved structural configurations for powered movement of the lift arm structure 330 by various actuators.

In particular, as facilitated by the upwardly protruding structure of the bridge structure 335, the lift actuators 350 may attach to the lift arm structure 330 above a top surface of each of the lift arms 332. As shown in FIG. 15, the lift actuators 350 may thereby extend and retract along the lifting axis L1 (see also line 358, FIG. 10) to pivot the lift arms 332 about the lift arm pivot point 338.

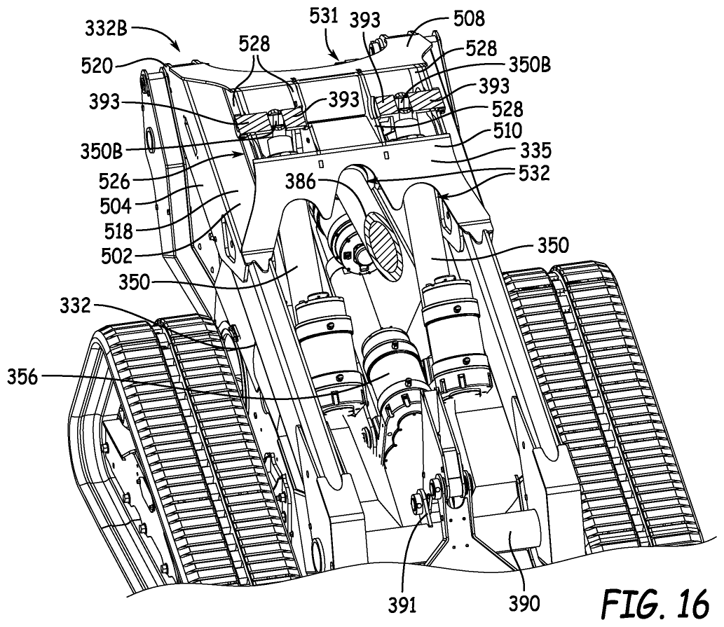

Further, in the illustrated example, the bridge structure 335 also pivotally supports the tilt actuator 386 within the internal volume of the bridge structure 335. The tilt actuator 386 can also be secured above the top surfaces of the lift arms 332 (as desired), with corresponding improvements to packaging and alignment of actuator forces. As also shown in FIG. 15, the tilt actuator 386 can thus extend and retract along the tilting axis T1 (see also axis 388, FIG. 10), can be disposed between the two lift actuators 350 (see also FIGS. 16-18). As a further improvement for packaging and for alignment of working loads, this arrangement can also orient the tilt actuator to be vertically aligned with (and above) the extension actuator 356. As also discussed above, the different actuators 350, 356, 386 may be controlled to extend or retract simultaneously or individually, along the different axes L1, T1, E1, to operably move the lift arm structure 330 (e.g., within a lift envelope 400 as depicted in FIG. 12), and the alignment of the various axes L1, T1, E1 can change in predictable ways during such movement, relative to what is shown in FIG. 15.

To appropriately align and support the various pivoting joints and cross members, a bridge structure can include various external and internal support structures. As best shown in FIG. 14, for example, the bridge structure 335 includes a base plate 502 on each lateral side, each of which transitions into an outer flange 504 and an inner flange 506. Likewise, the base plate 502 can be integrally formed with (or otherwise connected to) the flanges 504, 506 to provide a mounting body 518, with a U-shaped profile. The mounting body 518 can be secured (e.g., welded) to seat on and around the lift arm 332 and thereby to securely and rigidly connect the bridge structure 335 to the lift arms 332 (e.g., as permanently connected by various welds).

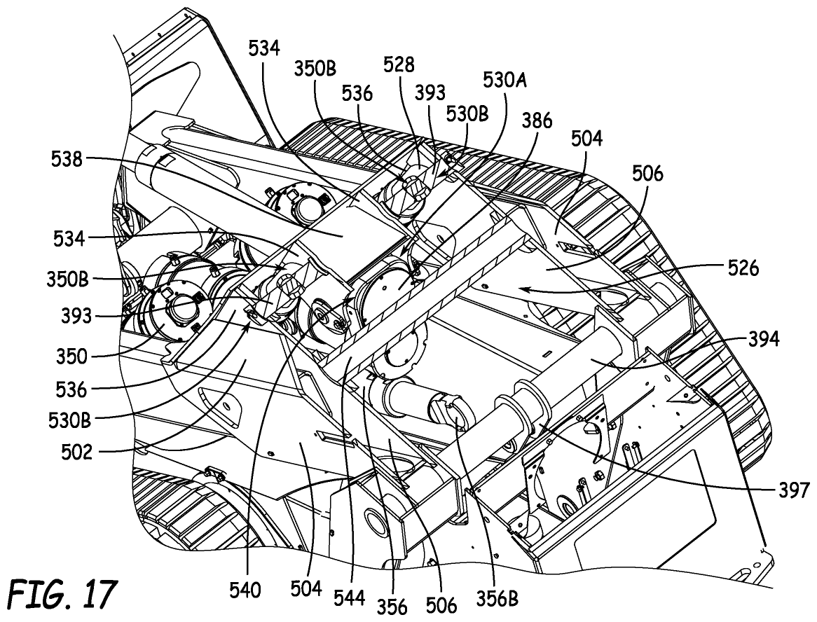

The bridge structure 335 further includes an upper shield that is rigidly secured to and extends above the mounting body 518. In the illustrated example, the upper shield is integrally formed to include a rear panel 508, a front panel 510, and a top panel 512, although other configurations are possible and shielding can also be provided by other features (e.g., outboard gussets 536, further discussed below). In some cases, the base plates 502 can angle upwardly to support the bridge structure 335 (e.g., a shield structure thereof). For example, the base plates 502 can extend above a top surface of the lift arm 332 to buttress the front panel 512 and the plates that form the inboard flanges 506, as shown in FIG. 17. In other examples, however, differently configured base plates or mounting bodies are possible.

In some examples, a bridge structure for a lift arm can also help to pivotally secure the lift arm to other structures, including other movable links of a lift arm linkage structure. For example, as shown in FIG. 17 the flanges 504, 506 of the mounting body 518 can also extend rearward, in parallel with one another, to further define a mounting structure 520. The mounting structure 520 can thus define and extend the rearward (proximal) end 332B of the lift arm 332 to provide support structure for the lift arm pivot points 338. In other words, the mounting body 518 provided by the bridge structure 335 may pivotally couple the lift arms 332 to the connecting link 334 at the lift arm pivot point 338.

In some examples, a bridge structure can define a generally arched structure that extends at oblique angles upwardly from a lift arm. For example, as also discussed above, the mounting bodies 518 seated on the lift arms 332 are connected to (and by) the rear panel 508 and the front panel 510. In particular, the rear panel 508 extends from the rear end of the base plate 502 of the mounting body 518 at a first acute angle A1 and the front panel 510 extends from a front end of the base plate 502 of the mounting body 518 at a second acute angle A2 (see FIG. 15). In some embodiments, the first angle A1 may be identical to the second angle A2. In some embodiments, the first angle A1 may be larger than the second angle A2. In some embodiment, the first angle A1 may be smaller than the second angle A2.

Also in the illustrated example, the rear panel 508 and the front panel 510 are connected by the top panel 512 so that the panels 508, 510, 512 collectively define an internal volume 526 (see, e.g., FIG. 15). As further detailed herein, various structures can be included within an internal to provide further mounting locations for various actuators, as well as improved overall structural support. As best shown in FIG. 15, the internal volume 526 may be a domed or open-bottomed trapezoidal (open-bottomed) shape, which can help to beneficially balance structural rigidity with sufficiently elevated locations of attachment joints for one or more actuators. However, other configurations may be possible.

In some cases, a bridge structure (e.g., a shield thereof) can include cutouts to provide enlarged openings for access into the internal volume of the bridge structure. Referring now to FIG. 16, for example, the rear panel 508 can include an arced cutout 531, and the front panel 510 may include cutouts 532. The cutouts 531, 532, for example, may allow for improved fluidic exchange of gases (e.g., air) for cooling, accessibility to mechanical components, and maneuverability of actuators. In particular, for example, the cutouts 532 of the front panel 510 can allow for relatively elevated locations of joints for the tilt and lift actuators 386, 350, while helping to prevent interference between the front panel 510 and the actuators 386, 350 during operation.

As shown in FIGS. 16 and 17 in particular, the internal volume 526 of the bridge structure 335 includes and is further defined by a plurality of support gussets 528, 534, as well as a plurality of cross members (e.g., torsion tubes as discussed above) and various pivoting joints for actuators. In different embodiments, a variety of such structures are possible. For example, in the configuration shown, the support gussets 528 extend longitudinally between the rear panel 508 and the front panel 510 of the bridge structure 335 and are parallel with each other. In some examples, four of the gussets 528 can be provided (as shown in FIG. 16), although other configurations are possible. In some examples, the plurality of support gussets 528 can be secured to the torsion tube 544 (e.g., to extend orthogonally therefrom), to provide substantial structural rigidity for the bridge structure 335 alone as well as the bridge structure 335 and the lift arms 332 in combination.

In some cases, as also noted above, support gussets or other internal structures of a bridge structure can provide support for pivoting joints with various actuators, including as can allow the beneficial alignment of actuator joints (e.g., as also discussed above). In this regard, for example, the plurality of support gussets 528 provide a set of actuator mounts 530A, 530B, to pivotally support the tilt actuator 386 (e.g., at a base end, as shown) and the lifting actuators 350 (e.g., at the extension ends 350B, as shown). As shown in FIG. 17, adjacent sets of gussets 528 may define various clevis-mount arrangements for the actuator mount 530A, 530B. In particular, the gussets 528 can include outboard gussets 536 and inboard gussets 534, with the inboard gussets 534 disposed within the internal volume 526 and the outboard gussets 536 further defining the outboard bounds of the internal volume 526. As mentioned above, the outboard support gussets 536 and the inboard support gussets 534 can be parallel to each other and the torsion tube 544 is perpendicularly secured only between the inboard gussets 534. In the illustrated example, as shown in FIG. 17 in particular, the outboard gussets 536 can be formed from the same plate structure as the inboard flanges 506. In other embodiments, other configurations are possible. Similarly, in some cases, further cross members for support can be provided, including a brace plate 538 (as shown) that is disposed between the two inboard support gussets 534.

In the illustrated example, the two inboard support gussets 534 and the brace plate 538 define a recessed area 540 for the actuator mount 530A for the tilt actuator 386, with the inboard support gussets 534 in particular providing a clevis mount arrangement for the tilt actuator 386 below the brace plate 538. Thus, the brace plate 538 can provide improved structural stability between the two inboard support gussets 534, at the actuator mount 530A in particular, by helping to redistribute stress concentrations from loading of the tilt actuator 386.

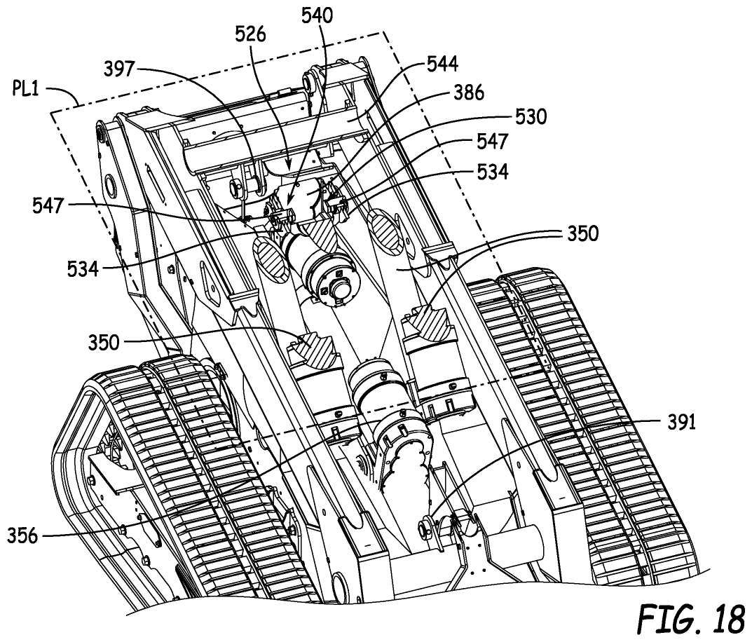

Further, in some embodiments, the torsion tube 544 may align with the actuator mount 530A of the tilt actuator 386—and a pivot axis of the actuator mount 530A, in particular—along a plane parallel to the lift arms 332. As illustrated in FIG. 18, for example, the gussets 534 support pins 547 to define a pivot axis at the end connection 386A of the tilt actuator 386 that is aligned with the torsion tube 544 along a plane PL1 that is parallel to the top surfaces of the lift arms 332 (and substantially parallel with an elongate direction of the lift arms 332 overall, not including the downward bending knee and implement carrier portion at the front end 332A).

As also shown in FIG. 17, and as generally discussed above, support structures of a bridge structure can also provide pivoting support for a lift actuator. For example, adjacent sets of the gussets 534, 536 can support pins 393 for clevis-style connection of the lift actuators 350 to the bridge structure 335 and thereby to the lift arm structure 330 overall. In particular, the upward extension of the bridge structure 335 (and the support gussets 534, 536) can thus allow the lift actuators 350 to be connected with a beneficial location, spacing, and orientation relative to the lift arm 330 and the various other actuators 386, 356. Such an arrangement, for example, can help to provide beneficial relative alignments of pivoting joints and lines of action for the various actuators, as further discussed above and below. Further, as shown in FIGS. 15 and 17 in particular, the lift actuator mounts 530B can in some cases be usefully located as a highest pivoting connection on the power machine (with the lift arm 330 fully lowered), while still being horizontally aligned with the torsion tube 544 for appropriate structural support.

In some cases, bridge structures as disclosed herein can help to provide particularly compact workgroup arrangements. More specifically, a bridge structure can generally provide additional space to arrange mounting locations for the actuators for a lift arm structure, including with one or more advantageous alignments as also discussed herein. For example, as also shown in FIG. 15, because of the additional mounting space provided by the bridge structure 335 (e.g., as shown for the tilt actuator 386 and the lift actuator 350), the actuators of the lift arm structure 330 can be very compactly arranged within the frame 310. In particular, in the example shown, all of the workgroup actuators 350, 356, 386 are arranged laterally between the lift arms 332 (and within he lateral footprint of the frame 310), for a particularly compact overall profile. Further, at least a portion of the actuators (e.g., the actuators 350, 386) can be partially housed within the bridge structure 335 for further space efficiency. However, in other arrangements, some actuators may be disposed laterally to the outside of particular lift arms or lift arm structures.

Bridge structures as shown herein can also provide improved structural support. In some cases, the torsion tube 394 may independently provide sufficient cross-support for the lift arms 332. However, the bridge structure 335 extending between the lift arms 332 provides additional rigidity to the lift arms 332 and structural support to counteract the induced loads. Furthermore, the bridge structure 335 can be contoured prevent debris from accumulating and entering the actuators disposed within the bridge structure 335.

In some embodiments, actuators can be mounted outboard of a lift arm or a frame. For example, the any or all of the workgroup actuators 350, 356, 386 can in some examples be mounted at similar or different locations that are outboard of the lift arms 332 or the frame 310. For example, the lift actuators 350 can be mounted outboard of the lift arms 332 and above the traction system 240. In some cases, the bridge structure 335 can provide mounting locations for both the lift and tilt actuators 350, 386. Additionally, and alternatively, the tilt actuators 386 can be otherwise mounted above or below the lift arms 332.

In some embodiments, additional, fewer, or alternative actuators can be mounted to the bridge structure 335 or the frame 310. For example, instead of a single tilt actuator 386 as illustrated in FIG. 14, two tilt actuators can be mounted to the bridge structure 335 or other parts of the lift arm structure 330 (e.g., the lift arms 332). Further, as generally noted above, the number of other actuators (e.g., lift or extension actuators) or mounting locations thereof can also be varied. In some embodiments, one or more lift actuators can be pivotally secured to a connecting link (or other lift arm link) rather than directly to a power machine frame. For example, as also discussed above, a lift arm can extend between a connecting link and a lift arm, rather than between a lift arm and a frame.

In some cases, a lift arm structure can also include improved joints between a lift arm and a connecting link. Referring to FIGS. 19 and 20, for example, a lift arm attachment structure 550 is illustrated. The lift arm attachment structure 550 aligns with and defines the lift arm pivot point 338, and includes an outboard support structure 552 (e.g., an outboard plate) and an inboard support structure 554 (e.g., an inboard plate) that is opposite the outboard support structure 552. In particular, the outboard support structure 552 and the inboard support structure 554 provide a clevis mount structure that receives a mounting pin 556 to pivotally secure the lift arms 332 (via the extended mounting structure 520 provided by the bridge structure 335). Thus, the lift arms 332 are supported by and pivot between the outboard structure 552 and the inboard structure 554 on respective sides of the lift arm structure 330.

In some embodiments, a cross member for a connecting link can extend through support structures for a lift arm pivot point, to provide even further structural strength for a lift arm structure overall. For example, as further illustrated in FIG. 20, the torsion tube 394 for the connecting link 334 extends between the lift arm attachment structures 550, and in particular between (and through) the inboard support structures 554 and the outboard support structures 552. Thus, the torsion tube 394 can provide improved rigidity and uniformity of response between the lift arm attachment structures 550, and between opposing lateral sides of the lift arm structure 330 overall. Further, the spaced apart configuration of the inboard and outboard support structures 554, 552 can provide improved operational support and structural rigidity relative to the pivoting joint between the connecting link 334 and the extension actuator 356 (e.g., relative to the joint at the cammed connecting structures 397 along central axis CA, in the illustrated example).

FIG. 20 also illustrates an internal shield 568 that extends laterally between the lift arms 332 on an opposite side of various actuators from the bridge structure 335. In the illustrated example, the internal shield 568 is formed from a contoured panel that is mounted above the main frame 310 and the traction system 340, and generally below all of the actuators of the lift arm structure 330. Similar to the bridge structure 335, the internal shield 568 can provide additional protection for the actuators from below and behind, and can also shield a power system (e.g., battery pack) of the loader 300 from above and ahead. However, the shield 568 may not necessarily provide direct structural support or mounting for various actuators, in contrast to the bridge structure 335.

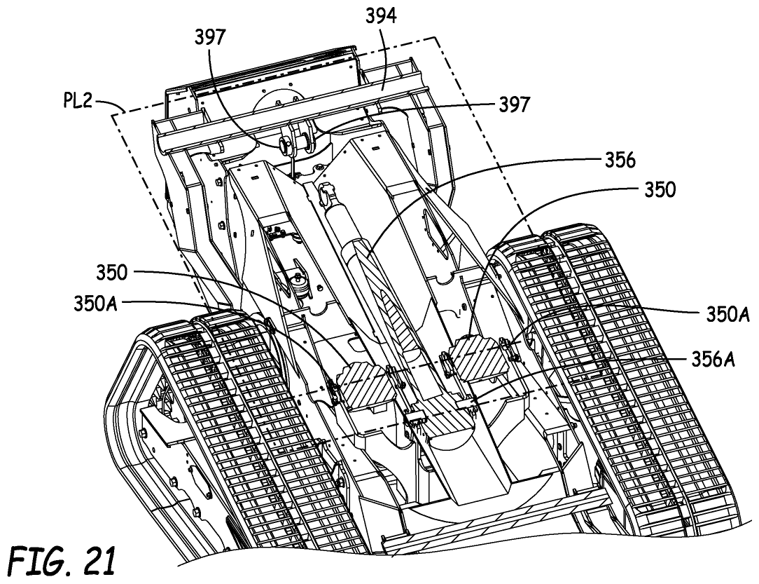

In some examples, other beneficial alignments can additionally (or alternatively) be provided. For example, referring to FIG. 21, the lift actuator 350 may be mounted to the frame 310 with a pivot axis at the frame end 356A of the extension actuator 356 that is in alignment with the torsion tube 394 along the plane PL2 that is parallel with a top surface of the lift arms 332. In contrast, a line of action of the extension actuator 356 may be out of alignment with the plane PL2, due to the offset provided by the cammed connecting structure 397.

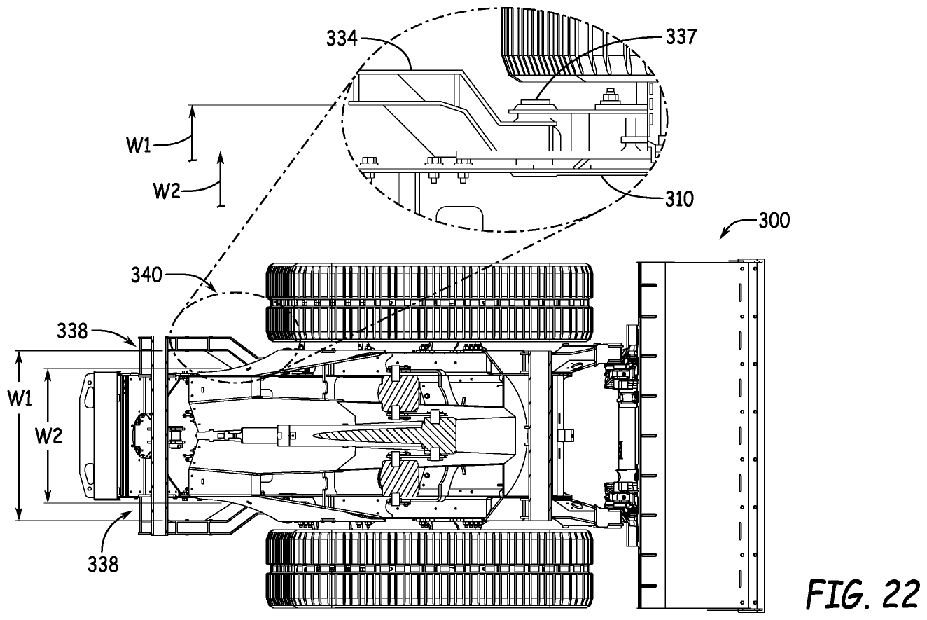

Also to provide improved packaging and force distribution, an connecting link can extend outward from a frame to engage a lift arm. In some examples, this arrangement can help to laterally align a pivoting connection between a lift arm and a connecting link with a pivoting connection between the connecting link and a frame of the power machine (i.e., so that the joints extend at overlapping lateral distances from a centerline) or can dispose the pivoting connection with the frame at least partly inboard of the pivoting connection with the lift arm. Referring to FIG. 22, for example, a maximum width W1 as measured at the lifting arm pivot points 338 on the connecting link 334 is larger than a maximum width W2 between opposite sides of the connecting link 334 as measured at the connecting link pivot point 337. The larger width W1 at the lifting arm pivot point 338 can provide structural stability to the lift arms 332 at the pivotal connection between the connecting link 334 and the lift arms 332. Further, the smaller width W2 can allow for more compact arrangements at the connecting link pivot points 337 between the connecting link 334 and the main frame 310 of the loader 300, particularly at locations adjacent to the traction system 340. This enables the connecting links 334 to pivotally move over an improved range of motion without interfering with the traction system 340. Moreover, in some cases, such a spacing can also allow a lift arm pivot point to be laterally aligned with a connecting link pivot point (e.g., as shown for the pins that define pivot points 338, 337 for the loader 300), with corresponding benefits for load distribution and efficiency of movement.

Some power machines according to the disclosure can include two (or more) separate and removably connected frames that are arranged to independently support separate components of work, tractive, and power systems of the power machine. For example, some power machines as variously discussed above can include a more rigid frame that is structured to support work and tractive actuators for the power machine (e.g., all such actuators), and a less rigid frame that is structured to support a main power source of the power machine (e.g., battery or other electrical power source). In particular, some examples of such frames can be removably secured together into an operational configuration while independently supporting the corresponding power machine components (e.g., with the first frame supporting tractive assemblies and work and tractive actuators, and the second frame supporting a battery and a battery management system). Further, in some cases, the frames can be easily separated and then re-connected, as needed, for improved efficiency and user ease during various service (or other) operations, including while the frames still support the respective workgroup, drive, and power system components.

As well as improved packaging and structural efficiency, such an arrangement can allow for improved manufacturing processes, including due to the potential for to separately prepare each frame as a sub-assembly, with various work elements and power source components already attached to the relevant sub-assembly before the sub-assemblies are joined together. In some cases, this can readily permit efficient modular manufacturing approaches as well as improved access for service of particular components or systems (e.g., a power system, a drive system, or a lift arm structure and related actuators).

In particular, some examples can include a first frame that provides a structural bridge across a power source that is supported on a second frame. The first frame can thereby support tractive and workgroup actuators and various other components relative to the second frame, whereas the second frame can support the power source relative to the first frame. Further, in some cases, the first frame can thus effectively reinforce the second frame, allowing the second frame to be constructed in a lighter or otherwise more easily serviceable form. In particular examples, a bridge frame can independently support one or more drive motors, lift actuators, extension actuators, lift arm structures, or tractive elements (e.g., wheels or tracks) relative to a base frame that supports a battery assembly to power the actuators on the bridge frame.

In general, a bridge frame (e.g., as further described below) can structured be self-supportive relative to the various actuators and other components attached thereto, regardless of whether a base frame is secured thereto. Accordingly, in some cases, a base frame can be easily installed onto or removed from a bridge frame to easily install or remove a battery from the power machine or perform various other manufacturing or maintenance operations.

In some cases, a bridge frame can include welded or otherwise joined side box structures on opposing lateral sides of a first frame. The side box structures can provide pivotable and other mounts for tractive and workgroup elements, and can be connected at upper ends by one or more structural cross members (e.g., various structural gussets). This type of arrangement can thus provide, and structurally also tie together, appropriately robust exterior (and outboard) structures to support various actuators, workgroup and tractive assemblies, and pivotable mounts (e.g., for a lift arm structure, or for tractive, lift, or extension actuators). Moreover, the side box structures can be further tied together by structures of a base frame, when the base frame is operationally secured to the bridge frame. For example, a base frame can be removably secured to a bridge frame along a bottom portion of the bridge frame and along an upwardly extending rear portion of the bridge (and base) frame to provide even further overall structural strength. Thus, although a base frame may generally provide a substantially less rigid structure than a bridge frame (e.g., for improved maneuverability), a base frame that supports a power source can be secured to a corresponding bridge frame to further enhance overall structural integrity of a power machine, while also providing the various benefits for manufacturing and service noted above.

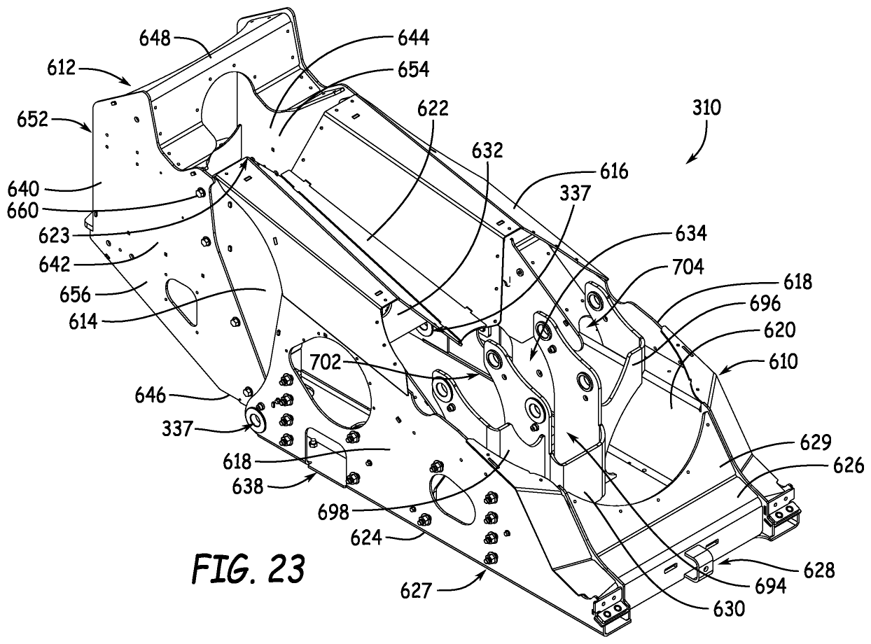

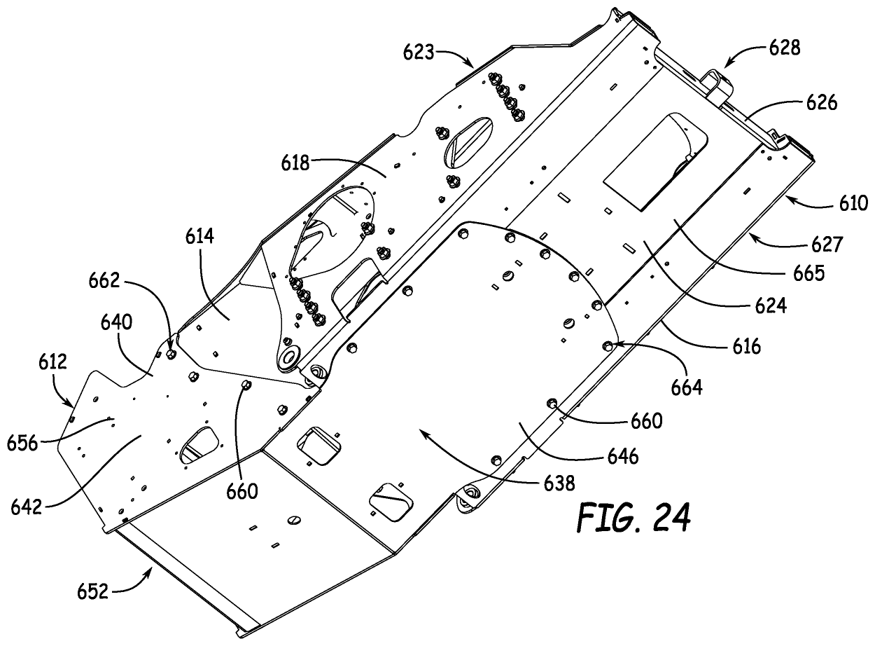

As one example, FIGS. 23 and 24 illustrate a bridge frame 610 and a base frame 612 which are removably secured to one another to form an example configuration for the frame 310 of the loader 300 of FIG. 14. The structures of the frames 610, 612 are laterally symmetrical across a front-to-back centerline of the loader 300 in the examples shown, although other configurations are possible. Accordingly, discussion or illustration of structures on one lateral side of either of the frames 610, 612 should be understood to be equally applicable to the opposing lateral side. In some case, particular benefits may accrue from use of the disclosed multi-piece frame structure with power machines configured as loaders, and particularly those having lift arm structures as discussed herein. In other examples, however, the frame 310 as shown in FIGS. 23 and 24 or other multi-piece frames according to this disclosure can be used for other power machines not limited to loaders.

In the illustrated example, different structural plates components (e.g., plates) of the bridge frame 610 can be coupled together in various known ways (e.g., with welds) to provide an appropriately rigid support structure. For example, to support tractive assemblies and a lift arm structure, the bridge frame 610 includes a welded first side box structure 614 and a welded second side box structure 616. The box structures (as well as other components of the bridge frame) may also utilize bends, cuts, etc. in the plates to facilitate forming the desired shapes. Each of the first and second side box structures 614, 616 defines, respectively, an outboard side profile 618 and an inboard side profile 620 opposite of the outboard side profile 618. The side box structures 614, 616 thus define various rectangular and other box shapes (with internal reinforcement as appropriate) to provide a rigid attachment structure to secure tractive and workgroup work elements (e.g., as further discussed below) as well as base frame 612.

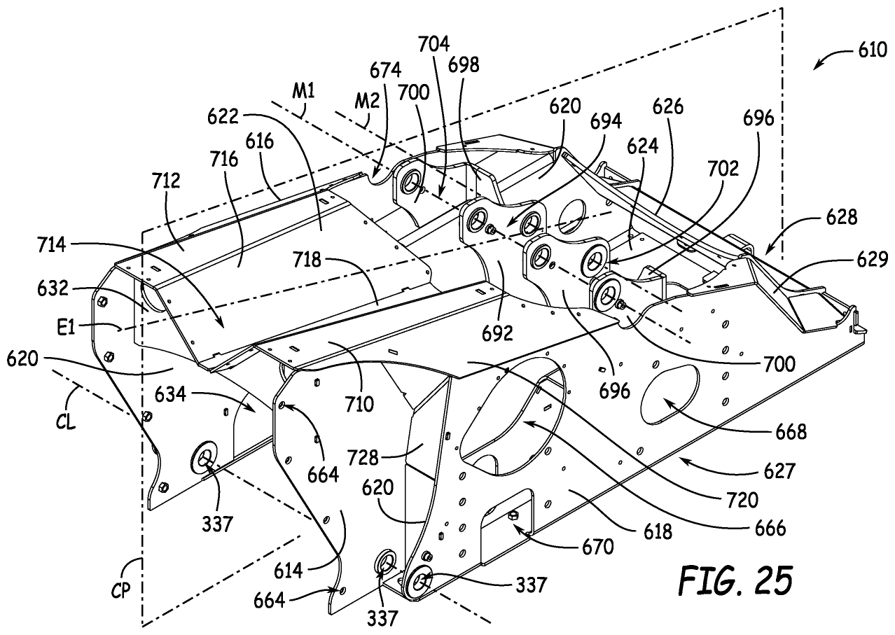

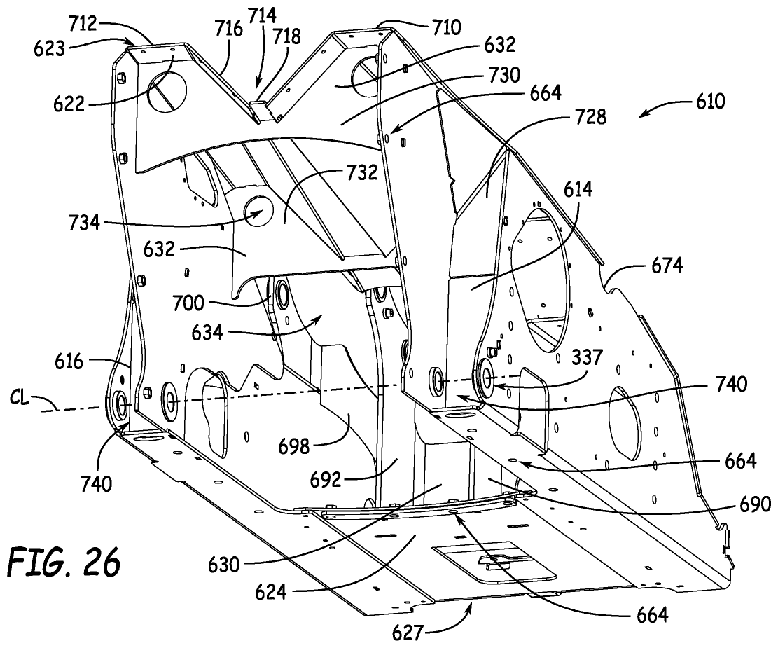

To laterally reinforce the side box structures 614, 616 relative to each other, a cross-support structure configured as a frame bridge structure 622 extends between the first and second side box structures 614, 616 along an upper end 623 of the frame 310, opposite of a base plate 624. In some examples, the bridge structure 622 can include various gussets 632 extending between the first and second side box structures 614, 616 within an internal volume 634 of the bridge structure 610 (see also FIGS. 25 and 26). The gussets 632 and other interior structures of the bridge frame 610 can generally be arranged as appropriate to ensure sufficient space for a power source and related components within the internal volume 634 (e.g., for easy initial assembly or for later exchange of swappable power sources, as further discussed below). To provide further rigidity, a front cross member 626 also extends between the first and second side box structures 614, 616, along a lower end 627 of the frame 310 at a front end 628. The front cross member 626 can include a front shield 629 that extends upwardly from the front cross member 626 between the first and second side box structure 614, 616, with the shield 629 angled forward and down in the illustrated example to provide improved shedding of debris off of the frame 310 of the loader 300.

To support various actuator mounts, the bridge frame 610 further includes a central tower 630 that extends upwardly from the base plate 624 between the first and second side box structures 614, 616. Generally, such a central tower can include various structures for pivotable connection to various actuators coupled to the workgroup. The pivotable connections may include, for example, clevis, trunnion, or other style mounts, including as further discussed below relative to the illustrated example. In some cases, as further discussed below, the central tower 630 can support multiple workgroup actuators with one or more axes of rotation (e.g., one or more tilt actuators and lift actuators).

As also shown in FIGS. 23 and 24, a rear tower 640 of the base frame 612 includes a first side wall 642 and a second side wall 644 connected to a base pan 646 along the lower end 638 of the frame 310. The first and second side wall 642, 644 of the rear tower 640 is connected by a top cross-member configured as a shield 648 that extends along the upper end 623 of the frame 310 (and the rear tower 640). Each of the first and second side wall 642, 644 of the rear tower 640 defines, respectively, an inboard surface 654 and an outboard surface 656 opposite of the inboard surface 654.

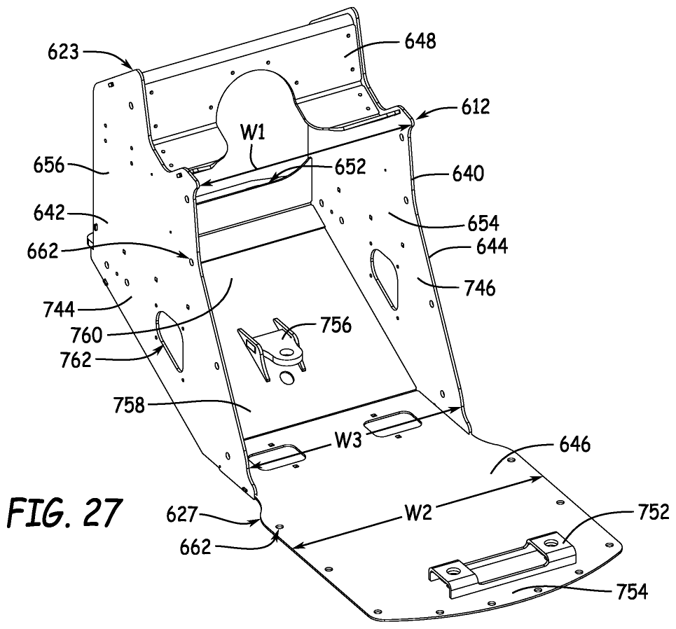

As generally noted above, the bridge and base frames 610, 612 can be removably secured together to collectively form the frame 310 of loader 300. For example, as illustrated in FIG. 24, the base frame 612 and the bridge frame 610 can be removably secured to one another by various fasteners 660 (e.g., threaded bolts, nuts, and washers). In particular, the base frame 612 includes a plurality of apertures 662 disposed along the periphery of the first and second side wall 642, 644 and the base pan 646 (see also FIG. 27). The bridge frame 610 includes a plurality of corresponding holes 664 (see FIGS. 25 and 26) disposed along the periphery of the first and second side box structure 614, 616 and the base plate 624. The plurality of apertures 662 and the plurality of holes 664 can be aligned concentrically to receive the fasteners mechanism 660 and thereby removably secure the base frame 612 and the bridge frame 610 together.

In some examples, a base frame can be seated underneath a bridge frame or outboard of a bridge frame at various connection points. In this way, for example, a comparably more rigid structure of the bridge frame can more readily provide lateral support for the base frame, and the base frame can be relatively easily removed from below (e.g., with the bridge frame raised on a lift). To elaborate, in the illustrated example, the first and second side box structures 614, 616 are secured to the rear tower 640 at locations in which plate extensions of the first and second side box structures 614, 616 extend along the inboard surfaces 654 of the first and second side wall 642, 644. Similarly, the base pan 646 of the base frame 612 is secured to the base plate 624 of the bridge frame at locations in which the base pan 646 extends along a lower surface 665 of the base plate 624. In this regard, for example, the bridge frame 610 can be generally considered to be nested into (and above) the base frame 612.

In different examples, different particular configurations for side box structures and bridge structures of a bridge frame are possible, including as relate to support of work or tractive elements and connection to a base frame. In this regard, FIGS. 25 and 26 illustrate further example details of the bridge frame 610 shown in FIGS. 23 and 24. In the illustrated example, as generally noted above, the first and second side box structure 614, 616 of the bridge frame 610 are (substantially) symmetrical about a central plane CP that extends along a front-to-back direction.

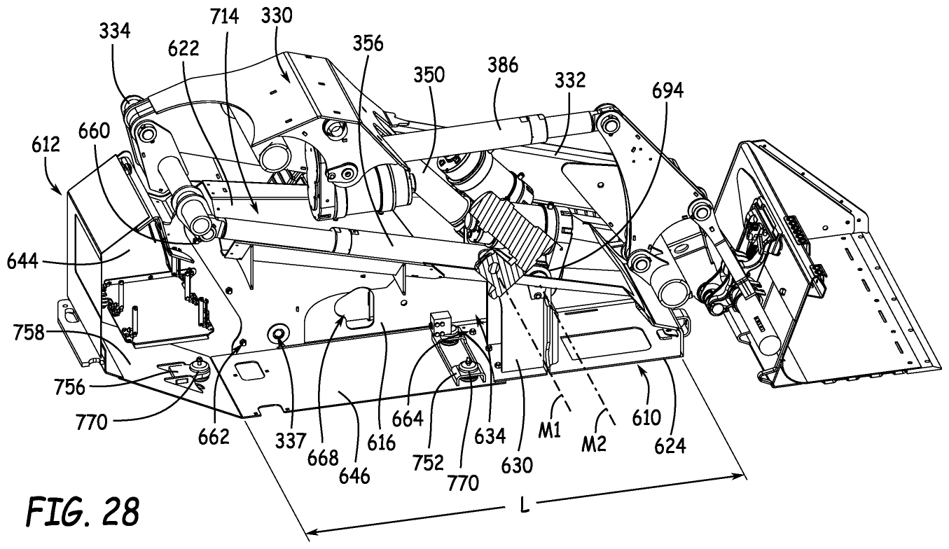

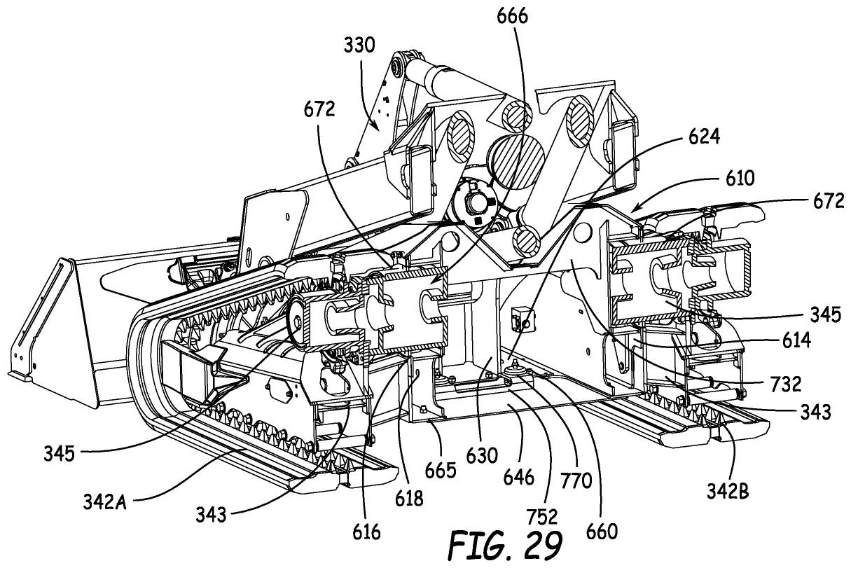

In particular, the first side box structure 614 includes, along the outboard side profile 618, a plurality of openings 666, 668, 670, and a plurality of mounting holes for fasteners. As also shown in FIGS. 28 and 29, the openings 666, 668, 670 and the plurality of mounting holes can be used to mount the track assemblies 342 to be operationally fully supported by the bridge frame 610. For example, the mounting opening 666 can receive a drive motor 672 into the side box structure 614 so that the drive motor 672 is appropriately aligned to provide tractive power to the corresponding track assembly 342. Similarly, the track frame 343 can be secured to the bridge frame 610 at or near the openings 668, 670 (e.g., via a torsional suspension system). In some embodiments, the openings 666, 668, 670, and/or the box structure 614 (more generally) can be used to route electrical wiring or other lines within the frame 310, or other openings can be variously provided.

As illustrated in FIG. 25 in particular, the bridge frame 610 includes the connecting link pivot point 337 that defines a connecting link rotational axis CL that extends between the outboard side profile 618 and the inboard side profile 620 of each of the first and second side box structure 614, 616 along the lower end 627. The connecting link 334 can thus be actuated relative to the bridge frame 610 by a relevant workgroup actuator (e.g., the extension actuator 356, as shown in FIGS. 15 and 21) to rotate about the connecting link axis CL. In this regard, a relatively low height for the pivot point 337 (e.g., within 10% or 20% of a total frame height from the bottom of the frame) can also beneficially locate the pivot point 337 in an area of particular strength on the bridge frame 610 and the frame 310 overall.

In general, the connecting link 334 can be connected within a pivot link mount 740 defined by the side box structure 614. In the illustrated example, the pivot link mount 740 is defined between the inboard side profile 620 and the outboard side profile 618 of the first and second side box structures 614, 616 adjacent to the base plate 624. In some examples, the pivot link mount 740 is defined along rearward plate extensions of the box structures 614, 616 at which the bridge frame 610 is secured to the base frame 612. In other examples, other configurations are possible, including with other mounting locations along a side box or other known styles of pivotable mount structures.

As briefly noted above, one or more workgroup actuators that are configured to move the connecting link 334 (and the lift arm structure 330 in general) can be mounted to the central tower 630 that extends from the base plate 624 of the bridge frame 610. In the illustrated example, a cut-out feature 674 is aligned to provide access to the pins that rotatably couple the central tower 630 to the workgroup actuator(s) 350. In some examples, as shown in FIG. 25, the feature 674 groove may thus be aligned along a first mounting axis M1 defined by the central tower 630, although other configurations are possible. In such a configuration, the pins may be aligned along M1 and installed into double shear mounting apertures of central tower 630 and actuator apertures via cut-out feature 674.

As shown in FIGS. 23 and 25, the central tower 630 can be formed as a branched structure that can collectively support multiple workgroup actuators. In particular, in the illustrated example, the tower 630 includes a first plate 690 and a second plate 692 that extend upwardly from the base plate 624 between the first and second side box structure 614, 616. The first plate 690 and the second plate 692 are spaced apart at a predetermined distance corresponding to the relevant workgroup actuator (e.g., the extension actuator 356 as shown in FIG. 21) and define a corresponding first pivot mount 694. In some cases, the plates 690, 692 can be rolled or bent sides of an integral plate structure forming at least part of the central tower 636. In yet other embodiments, plates 690/692 may be welded to a stem of the central tower.

To support additional actuators, further plates (e.g., welded or integral with the first and second plates 690, 692) can form a first branch 696 and a second branch 698 of the central tower 630. The branches 696, 698 can extend from the first and second plates 690, 692 toward the first and second side box structure 614, 616 respectively. The branches 696/698 provide appropriate spacing for a laterally spaced mounting arrangement of the workgroup actuators. For example, each of the first and second branches 696, 698 can include an outboard plate 700 that extends orthogonal to laterally extending plates of the first and second branches 696, 698, and parallel to the first and second plates 690, 692. The outboard plate 700 of the first branch 696 and the first central plate 690 define a second pivot mount 702, and the outboard plate 700 of the second branch 696 and the second plate 692 defines a third pivot mount 704 (e.g., with spacing and mounting apertures facilitating rotational coupling with the lift actuators 350 as shown in FIG. 21 via pins).

Various mounting configurations are possible, depending on the particular actuators to be secured. In some cases, multiple actuators can be supported relative to multiple pivot axes for the actuators. For example, the plates 690, 692, 700 include first mounting apertures defining a first mounting axis M1 and second mounting apertures defining a second mounting axis M2. As mentioned above, for example, the first mounting axis M1 can correspond to the lift actuators 350, and the second mounting axis M2 can correspond to the extension actuator 356 (e.g., secured forward of and below the first mounting axis M1, as shown). Generally, any or all of the first, second, and third mounts 694, 702, 704 can be a clevis mount structure or a trunnion mount structure that can pivotably mount the corresponding actuator (e.g., lift or extension actuators) about the first mounting axis M1 or the second mounting axis M2.

As well as provide structural strength between box structures 614/616, the cross-support bridge structure 622 can provide shielding for certain components and also help with shedding of and protection from debris as well as exposure to the external environment. In some examples, such a shield structure may extend between the power source and the one or more workgroup actuators to shield the power source from the actuators.

In some examples, the structure 622 can include a shield formed with a corrugated surface to more closely match the positions and ranges of motion of particular actuators. In the illustrated example, the structure 622 includes an upper shield plate that forms an M-shaped profile. In particular, a top plate of the structure 622 can form a first peak surface 710, a second peak surface 712, and a channel 714 defined between the first peak surface 710 and a second peak surface 712. The channel 714 can be defined by inner ramped panels 716 extending downwardly at an angle from the first and second peak surface 710, 712 toward a lower panel 718 that spans central plane CP. Further the inner ramped panels 716 can be connected by the lower panel 718 to provide a continuous shield surface and avoid a sharp valley profile that may inhibit debris shedding. Outer ramped surfaces 720 also extend outwardly from the peak surface 710, 712 at an angle at the upper end of the first and second side box structure 614, 616, ending adjacent to the outboard side profile 618 of the bridge frame 610.

As shown in FIG. 26, and as generally discussed above, one or more of the gussets 632 can be disposed between the upper ends of the cross-support structure 622 to provide structural support (e.g., prevent buckling of the inboard side walls and/or further support box structures 614/616). Generally, the one or more gussets 632 may extend downwardly toward a battery or other power source (not shown in FIG. 26) to provide additional structural support, while still providing sufficient clearance. In the illustrated example, the cross-support structure 622 includes a first gusset plate 730 and a second gusset plate 732 including one or more holes 734 to route electrical wires within the internal volume 634 of the bridge frame 610. In some examples, gussets or other reinforcing structures can extend between the first and second side box structure 614, 616 at locations not limited to the upper end 623 of the bridge frame 610.

In some examples, a bridge frame can be configured for improved debris shedding, as well as improved structural support. For example, the inboard side profile 620 and the outboard side profile 618 of the bridge frame 610 can provide substantially vertical profiles (e.g., but not vertical on average), which can help to shed debris from the bridge frame 610. With similar effect, and as also discussed above relative to the cross-support structure 622, exposed upper structures of the bridge frame 610 can provide substantially non-horizontal profiles (e.g., with only ramped surfaces as shown for the shield plate of the structure 622). In some examples, outboard side profile 618 and the inboard side profile 620 may be connected with a side shield 728 that closes a rearward portion of the side box structures 614, 616 to prevent debris from entering the internal volume thereof. The side shield 728 may extend between the upper end 623 of the cross-support structure 622 and the lower end 627 of the bridge frame adjacent to the connection link point 337, and plates to secure the bridge frame 610 to the base frame 612 (as also discussed above) can extend rearward of the shields 728. In some configurations the side shield 728 can also be substantially vertical.

In some examples, a threshold percentage of exposed surfaces of a bridge frame can exhibit particularly sloped surfaces, to ensure optimum shedding of debris. For example, at least a respective threshold percentage of top, inboard, or outboard surfaces of a bridge frame or sub-structures thereof that are exposed at the exterior of the bridge frame can be substantially non-horizontal (or substantially vertical). In some cases, 90% or more of the exposed surfaces of any (or all) of a top profile, an inboard side profile, or an outboard side profile of a side box structure of a bridge frame can be substantially non-horizontal (but not vertical) or substantially vertical. In other cases, however, other configurations are possible.

FIG. 27 illustrates further details of an example configuration of the base frame 612. As with the bridge frame 610, different structures of the base frame 612 can be coupled together by welding, can be integrally formed (e.g., bending, cutting, etc.), or can be otherwise assembled (e.g., with fasteners). As shown in FIG. 27 in particular, the width W1 between the inboard surfaces 746 of the rear tower 640 can be wider than the width between the exterior surfaces of the first and second side box structures 614, 616 of the bridge frame 610 (see, e.g., FIG. 26). Accordingly, the rear tower 640 can extend outboard of the bridge frame 610 where the two frames 610, 612 are connected in the nested configuration also discussed above.

In the illustrated example, the rear tower includes the top shield 648 that extends between the inboard surfaces 746 of the first and second side walls 642, 644. In some embodiments, the shape of the top shield 648 may follow the periphery of the upper end 623 of the first and second side wall 642, 644 and can be configured to generally align with the top of the cross-support structure 622 when installed (see, e.g., FIG. 23).

Different features can be provided in some examples to help secure a power source to a base frame 612. For example, the base frame 612 can include battery mounts 752/756 arranged along the base pan 646. In the illustrated example, the battery mounts includes a first battery mount 752 disposed along the base pan 646 near a first end 754 and the second mounting portion 756 disposed along a rear panel 758 of the base pan 646 at a second end 760 opposite the first end 754. However, a variety of mount configurations are possible including with known mount structures for battery or non-battery power sources (e.g., fuel cells or combustion-based power sources). The first and second battery mounts 752, 756 can support the battery (not shown) on and/or above the base pan 646 of the frame 310. This placement of the battery on/adjacent to the lower end 627 of the base frame 612 can provide benefits such as a lower center of mass and also a rear biased weight distribution.

In some embodiments, the base frame 612 may include a full rear shield (not shown) that extends between the top shield 648 and the base pan 646 (or otherwise along the rear tower 640) to fully enclose the rear end 652 of the base frame 612. In some embodiments, a slot 762 may be added along the first and second side wall 642, 644 to provide access to the electrical components or for other purposes. In some examples, the slot 762 can be used for mounting additional components (e.g., ultrasonic or other sensors for object detection).

Referring still to FIG. 27 and again to FIGS. 23 and 24, the illustrated configuration of the base frame 612 can thus facilitate secure and removable attachment between the base frame 612 and the bridge frame 610. For example, as shown in FIG. 27 the base pan 646 may include a region where a width W2 of the base pan 646 extends laterally wider than a local width W3 of rear tower 640 (e.g., with W3 equal to the width W1). Correspondingly, as shown in FIGS. 23 and 24, the tower 640 of the base frame 612 can extend outboard of the side box structures 614, 616, and the base pan 646 can extend even further laterally to be seated underneath the base plate 624 of the bridge frame 610. In other examples, however, other configurations are possible. Bridge frame 610 directly supports workgroup actuators and tractive elements and indirectly supports a power supply via the base frame 612. In some cases, the base pan 646 may extend along 30% or more of the length L of the base plate 624 of the bridge frame 612 where the frames 610, 612 are connected (see FIG. 28), although other configurations are possible. Generally, however, the configuration of the base pan 646 can be flexibly selected to accommodate particular sizes or weights of batteries or other power sources. For example, for longer batteries, the base pan 646 may extend longer than the illustrated configuration.

As shown in FIG. 28, the first and second battery mounts portions 752, 756 can support isolation mounts 770 (e.g., with mounting pads of various known types). The isolation mounts 770 can help to absorb internal impact energy or vibration, keep the battery aligned, and otherwise beneficially distribute operational forces across the range of compressions. In other examples, however, other configurations are possible.

As also mentioned above, FIG. 29 illustrates details of the connection between the track assemblies 342A/B and the bridge frame 610. In particular, the drive motor 672 is inserted into the bridge frame 610 at the opening 666, and the track frame 343 is secured to the outboard side profile 618 of the bridge frame 610. In the example shown, the second gusset 732 of the cross-support structure 622 can be aligned (partially) above the drive motors 672, to extend laterally therebetween, for reinforcement relative to the track assemblies 342 in particular. In other examples, however, other configurations are possible.

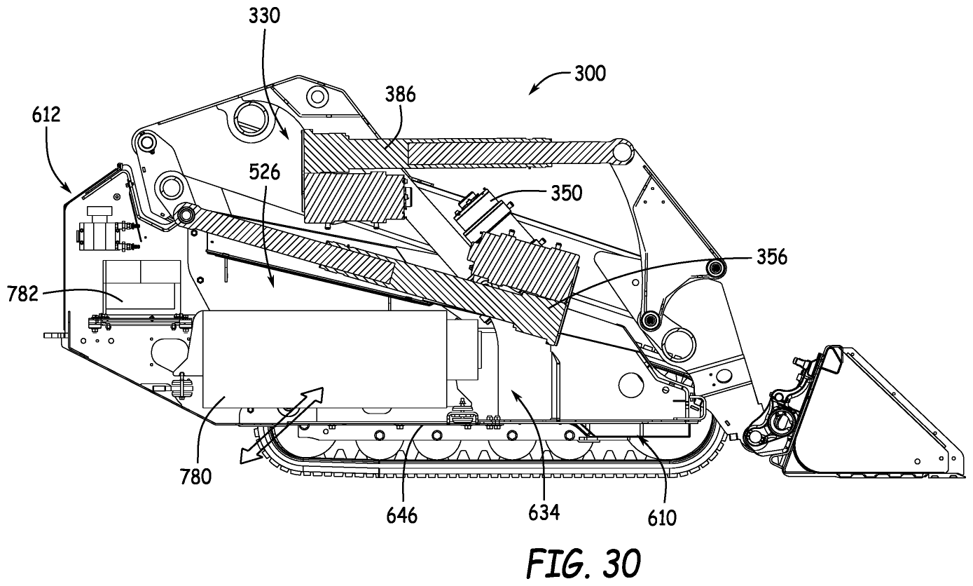

As shown in FIGS. 28-30 in particular, the bridge frame 610 thus includes all kinematic pivot points to support all of the actuator and kinematic loads from the track assemblies 342, the lift arm structure 330, and associated actuators, but does not directly support a battery 780 or other power source for those actuators. In contrast, referring specifically to FIG. 30, the base frame 612 directly supports the battery 780 and a corresponding control system 782 (e.g., CPU, motor controller, etc.), but does not directly support any lift arm structures, workgroup actuators, drive actuators, or other drive assembly components. Thus, the base frame 612 does not need to be structured to directly bear dynamic loading from operation of the power machine 300. Rather, the base frame 612 can be sized and structured primarily to support components to supply power or control functionality to workgroup or drive actuators (and corresponding drive or lift assemblies) as supported by the bridge frame 610. Thus, relevant systems can be separately assembled (or maintained) on the relevant frames 610, 612, and then the frames 610, 612 can be assembled together as needed (e.g., with each already populated with components as described above). In other words, the base frame 612 can provide support for power (and control) systems and can be assembled with the bridge frame 610, which provides actuators to be powered by the power source and work elements to be moved accordingly (e.g., lift arm structures and drive assemblies).

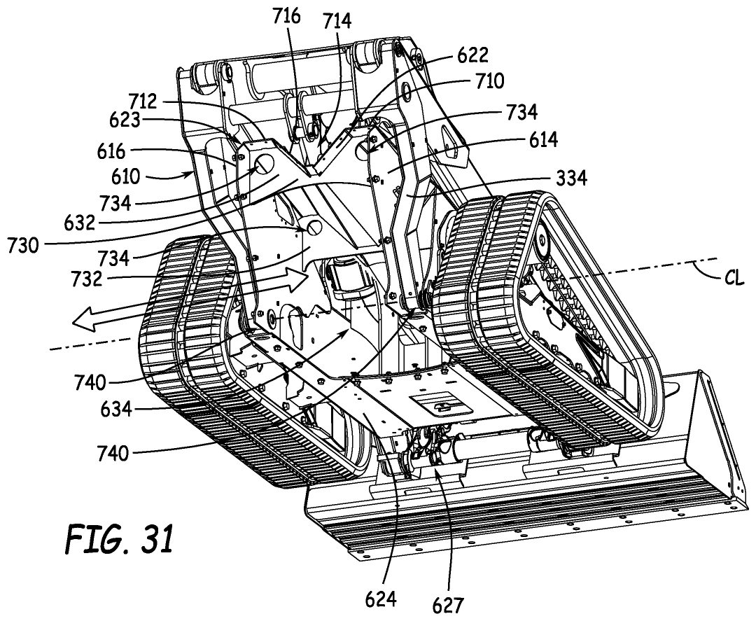

In some examples, the bridge frame 610 can be a standalone structure, configured to independently support its own weight and the weight of attached actuators, etc., without the base frame 612 attached. For example, as shown in FIG. 31, even with the base frame 612 removed, the bridge frame 610 can fully (and independently) support the various work elements required for operation of the power machine 300. In some cases, the illustrated bridge frame sub-assembly can be essentially ready for operation, needing only relevant power or control connections (e.g., connections to a power system that is pre-installed on base frame 612).

Thus, in some cases, the loader 300 can be partly dismantled by the removal of the base frame 612, to provide improved access for service of components within the internal volume 634 or of components supported on the base pan 646, etc. Accordingly, for example, the segmentation of the frame 310 into the bridge frame 610 including the workgroup and drive hardware (e.g., actuators, drive assemblies, etc.) and the base frame 612 including software and power components (e.g., battery and the control system) can allow easier maintenance for battery replacement, system updates, and easier access to the internal volume 634. In particular, during manufacturing or service, this segmentation can allow the power source (e.g., battery) to be mounted to the base frame 612 while actuators, a lift arm structure, and one or more drive assemblies are separately secured to the bridge frame 610 (e.g., in parallel operations). Prior to use, the loader 300 can then be assembled by securing the base frame 612 to the bridge frame 610 and completion of various associated transmission connections (e.g., for electrical power and control signals). Further, the loader 300 can be dissembled, partly or fully, by reversing the process as desired.

As also noted above, some examples of the disclosed removable base frame or bridge frame with an open lower (or rear) portion can allow for rapid and simple interchange of power systems for a mini-loader, tracked or skid-steer compact loader, or other power machine. For example, as shown in FIG. 31, the large open space provided by the internal volume 634 and the accessibility of the space from below or behind the bridge frame 610 can allow for relatively simple and highly efficient swapping of one power source for another (e.g., via a hot-swap interchange, in which a replacement power source is connected for power delivery to power machine systems via the movements of the power source that align the power source for operation). In particular, some implementations can thus allow for the base frame 612 and the battery 780 to be quickly and easily removed from below or behind the power machine 300 (e.g., collectively, as a unified battery assembly), as generally shown by block arrow in FIGS. 30 and 31.

For example, to replace a depleted or damaged battery, the power machine 300 can be driven or hoisted to an elevated position relative to a maintenance station, the fasteners 660 (see FIG. 24) can be removed, and then battery 780 (e.g., still attached to the frame 612), can be removed from the remainder of the power machine 300. A replacement battery (e.g., substantially identical to the battery 780, or on a replacement frame substantially identical to the frame 612) can then be installed into the internal volume 634 (e.g., with reversed operations) and the power machine 300 thus re-enabled for operation. Accordingly, the use of an improved frame structure as disclosed herein can correspond to an improved ability to swap depleted for fully-charged batteries and thus substantially extend the effective operational hours for any given power machine. Further, as also discussed above, the inclusion on the bridge frame 610 (or other upper frame) of the various pivot points for the lift arm structure 330 and related actuators can allow a power source to be swapped as described without necessarily disconnecting any actuators or other workgroup components (including tractive components).

In some embodiments, a base pan or other support for an interchangeable battery can be differently configured than the base pan 646 of the base frame 612. For instance, a base support similar to the base pan 646 can be formed separately from the base frame 612 so as to be attached to and detached from the base frame 612, or to be directly attached to and detached from the bridge frame 610. In some examples, the base pan 646 may not include the battery mounts 752 but may include an opening to receive a hot swappable or other battery (e.g., with a separate support structure being removably securable to the base pan 646 to secure the battery thereto). Thus, in some cases, a replacement battery can be inserted from the bottom end of the base pan 646 through an opening in the base pan 646 to power the power machine 300. In other cases, the rear panel 758 or other rearward frame structure can include an opening, such that a replacement battery can be inserted from a rear end of the base frame 612. In some examples, the base pan 646 or other support structure can be formed integrally with a battery (e.g., with or without including the rear tower 640), to secure the battery to the base frame 612.

Although the subject matter has been described in language specific to structural features or methodological acts, it is to be understood that the subject matter defined in the appended claims is not necessarily limited to the specific features or acts described above.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some embodiments, aspects of the invention, including computerized implementations of methods according to the invention, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the invention can be implemented as a set of instructions, tangibly embodied on a non-transitory computer-readable media, such that a processor device can implement the instructions based upon reading the instructions from the computer-readable media. Some embodiments of the invention can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some embodiments, a control device can include a centralized hub controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the invention, or of systems executing those methods, may be represented schematically in the FIGS. or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular embodiments of the invention. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

As also used herein, unless otherwise defined or limited, the terms “inboard” and “outboard” refer to a relative relationship (e.g., a lateral distance) between one or more objects or structures and a centerline of the power machine, along a lateral side of the power machine. For example, a first structure that is inboard of a second structure is positioned laterally inward from the second structure so that a distance between the first structure and the centerline of the power machine is less than a distance between the second structure and the centerline of the power machine. Conversely, a first structure that is outboard of a second structure is positioned laterally outward from the second structure so that a distance between the first structure and the centerline of the power machine is greater than a distance between the second structure and the centerline of the power machine.

Similarly, as used herein, unless otherwise defined or limited, the terms “interior” and “exterior” refers to a relative relationship (e.g., a lateral distance) between one or more structures (e.g., a sub-structure) and a centerline of a reference structure (e.g., a main structure) that extends in a front-to-back direction or between first and second ends of the reference structure. For example, an interior structure is disposed closer to a centerline of a reference structure than an exterior structure. In this regard, an outboard structure of a subassembly of a power machine may also be an exterior structure. In contrast, an exterior structure of a subassembly, relative to a centerline of the subassembly, may not necessarily be outboard of other components of the subassembly.

Also as used herein in the context of power machines, unless otherwise defined or limited, “tractive” or “drive” are used to designate to actuators and other work elements of a power machine that can be powered by a power source to cause movement of the power machine over terrain (e.g., wheeled or tracked ground-engaging elements, motors configured to power ground-engaging elements, and related assemblies). In contrast, “workgroup” is used to refer to actuators or other work elements of a power machine associated with powered operation of work elements that are not configured to provide powered travel over terrain (e.g., lift arm structures, attached implements, motors or other actuators to power movement of lift arm structures or attached implements, and related assemblies). Thus, tractive (or drive) actuators are arranged to power travel of a power machine whereas workgroup actuators are arranged to power non-travel work operations of the power machine. Correspondingly, discussion of workgroup functions refers to one or more functions provided by movement of one or more work elements of a power machine, whereas discussion of tractive (or drive) functions refer to one or more functions provided for movement of the power machine itself over terrain.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

In some implementations, devices or systems disclosed herein can be utilized, manufactured, installed, etc. using methods embodying aspects of the invention. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

What is claimed is:

1. A loader comprising:
a main frame;
a lift arm structure coupled to the main frame and moveable between a fully-lowered position and a fully-raised position, the lift arm structure including a lift arm pivotally supported relative to the main frame and actuators arranged to move the lift arm structure between the fully-lowered and fully-raised positions; and
a control system including an electronic controller configured to receive command inputs that indicate target movements of the lift arm and to provide corresponding outputs to control the one or more actuators;
wherein the electronic controller is configured to selectively operate in a radial lift mode, in which the control system controls the actuators based on the command inputs to move the lift arm along a radial lift path, and in a non-radial lift mode, in which the control system controls the actuators based on the command inputs to move the lift arm along a non-radial lift path.

2. The loader of claim 1, wherein the lift arm includes an implement pivot point at a first end that is configured to support an implement, and the lift arm structure includes a connecting link that pivotally supports the lift arm relative to the frame;
wherein the actuators include a lift actuator pivotally secured to the lift arm and an extension actuator pivotally secured to the connecting link; and
wherein the electronic controller is configured to control the lift actuator and the extension actuator collectively, to move the implement pivot point of the lift arm to any point within a lift envelope of the lift arm, the lift envelope being defined by a plurality of bounds.

3. The loader of claim 2, wherein the bounds include a plurality of:
a retracted bound defined by a first path of the implement pivot point as the lift actuator moves between a fully-extended position and fully-retracted position with the extension actuator at a first extension length;
an extended bound defined by a second path of the implement pivot point arm as the lift actuator moves between the fully-extended and fully-retracted positions with the extension actuator at a second extension length;
a lower bound defined by a third path of the implement pivot point as the extension actuator moves between a fully-extended position and a fully-retracted position with the lift actuator at a first lift length; and
an upper bound defined by a fourth path of the lift arm as the extension actuator moves between the fully-extended and fully-retracted positions with the lift actuator at a second lift length.

4. The loader of claim 3, wherein at least part of the retracted bound is defined with the first extension length of the extension actuator being a minimum arm-extension length of the extension actuator.

5. The loader of claim 4, wherein at least part of the extended bound is defined with the second extension length of the extension actuator being a maximum arm-extension position of the extension actuator.

6. The loader of claim 2, wherein, for a given extension of the lift actuator, movement of the extension actuator between the fully-extended and fully-retracted positions moves the implement pivot point along a corresponding extension path within the lift envelope; and
wherein different extensions of the lift actuator provide different curvature, respectively, for the corresponding extension paths.

7. The loader of claim 2, wherein, for a given extension of the extension actuator, movement of the lift actuator between the fully-extended and fully-retracted positions moves the implement pivot point along a corresponding lift path within the lift envelope; and
wherein different extensions of the extension actuator provide different curvature, respectively, for the corresponding lift paths.

8. The loader of claim 2, wherein the electronic control system is configured to restrict movement of the implement pivot point to an operational envelope within the lift envelope.

9. The loader of claim 1, wherein the electronic control system is configured to control the lift actuator and the extension actuator concurrently to selectively move the implement pivot point along a vertical direction and along a horizontal direction.

10. A method of operating a loader, the method comprising:
receiving, at an electronic controller, command inputs that indicate target movements of a lift arm, the lift arm being pivotally supported relative to a main frame of the power machine and being included in a lift arm structure that further includes actuators arranged to move the lift arm structure between a fully-lowered position and fully-raised position; and
selectively controlling the actuators, with the electronic controller:
in a radial lift mode, in which the actuator are controlled based on the command inputs to move the lift arm along a radial lift path; and
in a non-radial lift mode, in which the actuators are controlled based on the command inputs to move the lift arm along a non-radial lift path.

11. The method of claim 10, wherein the lift arm structure further includes a connecting link pivotally coupled to a main frame of the power machine and to the lift arm to pivotally support the lift arm relative to the main frame.

12. The method of claim 11, wherein the actuators include a lift actuator pivotally coupled to the lift arm and an extension actuator pivotally coupled to the connecting link; and
wherein selectively controlling the actuators includes:
moving the lift actuator between a retracted position and an extended position to pivot the lift arm relative to the connecting link; and
moving the extension actuator between a retracted position and an extended position to pivot the connecting link relative to the main frame.

13. A loader comprising:
a main frame;
tractive elements supported by the main frame; and
a lift arm structure coupled to the main frame and moveable between a fully-lowered position and a fully-raised position along radial and non-radial lift paths, the lift arm structure including:
a lift arm having a first end positioned forward of a second end when the lift arm is in the fully-lowered position, the first end of the lift arm defining a pivot connection for an implement, and
a connecting link having a first end pivotally coupled to the main frame at a connecting link pivot point, and a second end pivotally coupled at the second end of the lift arm at a lift arm pivot point;
a lift actuator configured to pivot the lift arm about the lift arm pivot point relative to the main frame and the connecting link; and
an extension actuator configured to pivot the connecting link about the connecting link pivot point to move the connecting link and the lift arm relative to the main frame.

14. The loader of claim 13, wherein the lift actuator is pivotally coupled at a first end to one of the main frame or the connecting link and at a second end to the lift arm, the lift actuator being configured to move between a retracted position and an extended position to pivot the lift arm about the lift arm pivot point to move the implement relative to the main frame; and
wherein the extension actuator is pivotally coupled at a first end to the main frame and pivotally coupled at a second end to the connecting link, the extension actuator being configured to move between a retracted position and an extended position to pivot the connecting link about the connecting link pivot point and thereby move the lift arm relative to the main frame.

15. The loader of claim 14, wherein the connecting link pivot point is at a lower height on the main frame than one or more of the first end of the lift actuator or the first end of the extension actuator.

16. The loader of claim 14, wherein, relative to a front-to-back direction defined by the main frame, the first end of the lift actuator is positioned forward of the second end of the lift actuator and rearward of the second end of the lift actuator.

17. The loader of claim 14, wherein the first end of the extension actuator is positioned at a lower height and, relative to a front-to-back direction defined by the main frame, in front of the first end of the lift actuator.

18. The loader of claim 17, wherein, relative to a vertical direction, the second end of the extension actuator is at a lower height than the second end of the lift actuator for any position of the lift arm structure between the fully-lowered position and the fully-raised position.

19. The loader of claim 14, wherein, with the lift arm in the fully-lowered position, the first end of the lift actuator and the first end of the extension actuator are pivotally secured to the frame at below the lift arm.

20. The loader of claim 19, wherein the second end of the extension actuator is positioned rearward of the second end of the lift actuator when the lift arm is in the fully-lowered position.
